(19) United States
(12) Patent Application Publication
(10) Pub. No.: US 2026/0214303 A1
(43) Pub. Date: Jul. 23, 2026

(54) INFORMATION PROCESSING DEVICE AND INFORMATION PROCESSING METHOD

(71) Applicant: SONY GROUP CORPORATION, Tokyo (JP)

(72) Inventors: Shimpei KAJIMA, Tokyo (JP); Chihiro KAWAGUCHI, Kanagawa (JP); Junichi IROKAWA, Kanagawa (JP); Shinichiro AOKI, Kanagawa (JP); Hayato KAGAMI, Tokyo (JP); Kazutoshi OHNO, Kanagawa (JP); Hiroo KADA, Tokyo (JP); Shunichi SUGIURA, Kanagawa (JP)

(73) Assignee: SONY GROUP CORPORATION, Tokyo (JP)

(21) Appl. No.: 19/139,382

(22) PCT Filed: Dec. 12, 2023
(86) PCT No.: PCT/JP2023/044344

§ 371 Date: Jun. 16, 2025

(30) Foreign Application Priority Data
Dec. 28, 2022 (JP) 2022-212645

(51) Int. Cl. H04N 21/485; H04N 21/4223; H04N 21/431

(52) U.S. Cl. CPC H04N 21/4852; H04N 21/4223; H04N 21/4316

(57) ABSTRACT

There is provided an information processing device and an information processing method that are capable of providing a UI suitable for the type of content as well as image quality settings or sound quality settings of the content. A UI is set according to setting content of image/sound settings related to at least one of an image and sound of content to be viewed by a user.

### TECHNICAL FIELD

The present technology relates to an information processing device and an information processing method, and more particularly to an information processing device and an information processing method that are capable of providing a UI suitable for the type of content as well as image quality settings or sound quality settings of the content.

### BACKGROUND ART

PTL 1 discloses a multi-window (multi-view) technology in which images from two or more image sources are displayed in separate windows on a television set.

### CITATION LIST

### Patent Literatures

PTL 1: WO 2020/031453

### SUMMARY

### Technical Problem

Television sets and monitors are commercially available that are made to be able to easily set various appropriate settings of image quality and sound quality according to the type of content by simply specifying a mode corresponding to the type of content. However, the user interface (UI) of these is not configured to suit the type of content.

The present technology has been made in view of such circumstances, and is designed to provide a UI suitable for the type of content as well as image quality settings or sound quality settings for the content.

### Solution to Problem

An information processing device according to the present technology is an information processing device including a processing unit that sets a UI according to setting content of image/sound settings related to at least one of an image and sound of content to be viewed by a user.

An information processing method according to the present technology is an information processing method including setting, by a processing unit of an information processing device, a UI according to setting content of image/sound settings related to at least one of an image and sound of content to be viewed by a user.

In the information processing device and the information processing method according to the present technology, an UI is set according to setting content of image/sound settings related to at least one of an image and sound of content to be viewed by a user.

### BRIEF DESCRIPTION OF DRAWINGS

FIG. 1 is a block diagram illustrating an internal configuration example of a television set to which the present technology is applied.

FIG. 2 illustrates a single-view image example displayed on a display unit.

FIG. 3 illustrates a multi-view image example displayed on the display unit.

FIG. 4 illustrates a multi-view image example displayed on the display unit.

FIG. 5 illustrates a single-view image example displayed on the display unit.

FIG. 6 illustrates a multi-view image example displayed on the display unit.

FIG. 7 illustrates a configuration example of a multi-view screen.

FIG. 8 illustrates a multi-view image example when performing an operation on focused content.

FIG. 9 illustrates an image example when switching between pieces of content displayed on a multi-view screen.

FIG. 10 illustrates an image example when switching between pieces of content displayed on a multi-view screen.

FIG. 11 illustrates a multi-view image example in which detailed information of content is displayed.

FIG. 12 illustrates a multi-view image example with information display turned off.

FIG. 13 is a diagram for explaining sound switching of content in multi-view.

FIG. 14 illustrates a multi-view image example in which a setting screen for sound output is displayed.

FIG. 15 illustrates a single-view image example in which content for which the image/sound setting mode is not a game mode is displayed on the display unit.

FIG. 16 illustrates a single-view image example in which content for which the image/sound setting mode is a game mode is displayed on the display unit.

FIG. 17 is a diagram illustrating an example of a UI for operating the screen size and position that are allowed to be operated when the image/sound setting mode is the game mode.

FIG. 18 is a diagram for explaining an app to which a UI is applied when the image/sound setting mode is the game mode.

FIG. 19 is an explanatory diagram for explaining an operation of a camera app.

FIG. 20 is a diagram for explaining automatic classification of a stationary posture and a walking posture.

FIG. 21 illustrates a display example of a program information screen for television broadcasts (terrestrial broadcasts and satellite broadcasts) on the television set.

FIG. 22 is a diagram for explaining a first form of high-speed scrolling in the vertical direction (channel direction) on the program information screen.

FIG. 23 is a diagram for explaining a first form of high-speed scrolling in the horizontal direction (time direction) on the program information screen.

FIG. 24 is a diagram for explaining a second form of high-speed scrolling in the vertical direction (channel direction) on the program information screen. It is a flowchart illustrating data processing executed by a data processing device.

FIG. 25 is a diagram for explaining a second form of high-speed scrolling in the horizontal direction (time direction) on the program information screen.

FIG. 26 illustrates a first display form of program information superimposed on an image of broadcast content.

FIG. 27 illustrates a second display form of program information superimposed on the image of the broadcast content.

FIG. 28 illustrates a third display form of program information superimposed on the image of the broadcast content.

FIG. 29 illustrates a fourth display form of program information superimposed on the image of the broadcast content.

FIG. 30 illustrates an example of a program information screen for program search.

FIG. 31 illustrates an image example on an Eco dashboard screen.

FIG. 32 is an explanatory diagram of an indicator.

FIG. 33 illustrates an example of a lookup table that associates setting values in eco setup with leaf sizes.

FIG. 34 is a diagram illustrating states of an indicator 312 depending on leaf sizes.

FIG. 35 is a flowchart illustrating a processing procedure of easy Eco setup.

### DESCRIPTION OF EMBODIMENTS

Embodiments of the present technology will be described below with reference to the drawings.

### «Television Set (Information Processing Device) According to Present Embodiment»

### (Configuration Example)

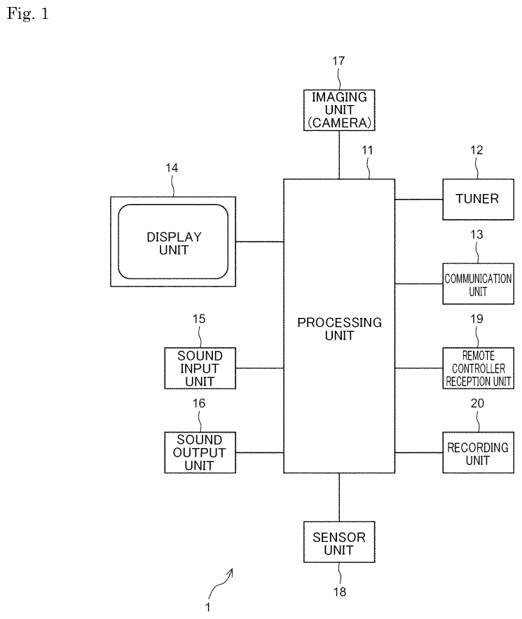

FIG. 1 illustrates a schematic diagram of an internal configuration example of a television set 1. However, the television set 1 may be an information processing device including a broadcast tuner. The illustrated television set 1 includes a processing unit 11, a tuner 12, a communication unit 13, a display unit 14, a sound input unit 15, a sound output unit 16, an imaging unit (camera) 17, a sensor unit 18, a remote controller reception unit 19, and a recording unit 20.

The tuner 12 selects and receives terrestrial and satellite broadcast signals. The communication unit 13 is connected to an external network such as the Internet through wired communication such as Ethernet (registered trademark) or wireless communication such as Wi-Fi (registered trademark). For example, the communication unit 13 transmits and receives data related to OTT services and visual communication, which are provided by a provider. The communication unit 13 includes a communication interface that transmits digital image and sound signals such as High Definition Multimedia Interface (HDMI) (registered trademark), and is available to externally connect a recorder and player such as for a Blu-ray or hard disk, a game machine, and the like to the television set 1. The communication unit 13 may be interconnected with each CE device in the home via a home network in accordance with standards such as Digital Living Network Alliance (DLNA) (registered trademark), and may further have an interface function with Internet of Things (IoT) devices.

The display unit 14 is made up of, for example, organic EL elements, has a large screen with an aspect ratio of 16:9, and is used to display images of program content selected and received by the tuner 12, an Electronic Program Guide (EPG), and data broadcasting content, as well as streaming content delivered by OTT services, and images of visual communication such as video conference. Images of applications pre-installed in the television set 1, such as a voice agent, and graphics such as an OSD generated within the television set 1 are also displayed on the display unit 14. A touch sensor may be superimposed on a part or the entire region of the screen of the display unit 14.

The sound input unit 15 is made up of a sound pickup element such as a microphone, and is used to receive sound generated in a room in which the television set 1 is installed. Sounds generated in the room may include speech by a viewer of a television program or a user using a voice agent. The sound input unit 15 may include a microphone array that combines a plurality of microphones. One, some, or all of the microphones may be externally connected to the television set 1. Alternatively, it may include a microphone mounted on a remote controller for the television set 1, or a microphone mounted on a device external to the television set 1, such as a smartphone or a wearable device. In the case where the sound input unit 15 includes a plurality of microphones, beamforming processing can be implemented to increase the pickup sensitivity of voice from a desired sound source position, such as voice of a user speaking to a voice agent, or conversely, to reduce the pickup sensitivity of voice from an unwanted sound source position, such as voice of another user or sounds output from another AV device in the room.

The sound output unit 16 is used to output sound of program content and data broadcasting content, which are selected and received by the tuner 12, as well as to output synthesized sound for a voice agent function. The sound output unit 16 is made up of a sound generation element such as a speaker. In the present embodiment, it is assumed that the sound output unit 16 includes a speaker array (a multi-channel speaker or a super multi-channel speaker) combining a plurality of speakers (one, some, or all of the speakers may be externally connected to the television set 1). Therefore, the sound output unit 16 can generate a sound field based on the output control of each speaker to localize a sound image at a desired position and make the sound difficult to hear from places other than the desired position.

Not only cone-type speakers but also flat panel-type speakers may be arranged in an array to be used as the sound output unit 16. Of course, a speaker array combining different types of speakers may also be used as the sound output unit 16. The speaker array may include one that outputs sound by vibrating the display unit 14 with one or more vibrators (actuators) that generate vibrations. The vibrators (actuators) may be in a form that can be attached to the display unit 14 later.

The imaging unit 17 includes a camera having an image sensor such as a Complementary Metal Oxyde Semiconductor (CMOS) or a Charge Coupled Device (CCD), and mainly shoots images in the front direction of the television set 1, for example, of a user in front of the large screen of the display unit 14 or the scenery inside the room. The imaging unit 17 may be, for example, a stereo camera using two cameras, or a multi-eye camera using three or more cameras. One, some, or all of the cameras may be externally connected to the television set 1. Hereinafter, the imaging unit 17 will also be simply referred to as a camera.

The sensor unit 18 mainly senses environmental information in a room in which the television set 1 is installed. Any configuration of the sensor unit 18 may be used, i.e., any kind of sensor elements may be included. For example, the sensor unit 18 may include an object detection sensor or a depth sensor. Based on the detection result of the object detection sensor or the depth sensor (as necessary, together with the image recognition result of an image shot by the imaging unit 17), the furniture installed in the room and the layout of the room can be detected. The sensor unit 18 may include an environmental sensor that detects environmental information, such as an illuminance sensor, a temperature sensor, or a humidity sensor. The sensor unit 18 may include an infrared sensor or a human sensor to detect the position and movement of the user within the room. The sensor unit 18 may include a biosensor that detects the user's pulse, sweat, brain waves, myoelectric potential, breath, and the like. One, some, or all of the sensors making up the sensor unit 18 may be externally connected to the television set 1 or wirelessly connected thereto.

The remote controller reception unit 19 receives and processes remote controller commands transmitted from a remote controller (not illustrated) through infrared communication, short-distance wireless communication, or the like. The operator of the remote controller is, for example, a viewing user of the television set 1 in a living room.

The recording unit 20 includes a large-capacity recording device such as a hard disc drive (HDD), and is mainly used to record program content received by the tuner 12. The recording unit 20 may be disposed within the television set 1, or may be externally connected to the television set 1 via an interface such as High Definition Multimedia Interface (HDMI) (registered trademark) or Universal Serial Bus (USB).

The processing unit 11 includes a processor and a memory, and executes programs loaded into the memory to perform various types of processing and generally control the operation within the television set 1. In the processing unit 11, various applications are executed basically under an execution environment provided by an operating system (OS). For example, when a multiprocessor is available, or when multithread execution is possible by the OS, all processing units that can be executed in parallel can be read into the memory and executed in parallel.

Processing to be executed by the processing unit 11 may include: operations within a device 100 such as channel selection, volume adjustment, recording, and image quality adjustment in response to remote controller commands received by the remote controller reception unit 19; image and sound output processing of program content selected and received by the tuner 12; playback output processing of program content recorded in the recording unit 20; playback output processing of streaming content delivered by OTT services; execution of applications (also called apps); and OSD display control. The applications to be executed by the processing unit 11 may include applications that have been pre-installed in the processing unit 11, such as data broadcasting applications received via the tuner 12 or the communication unit 13, OTT service applications, voice agents, visual communications, and the like. The processing unit 11 can execute a plurality of agent applications in parallel, so that the television set 1 can function as a plurality of agent devices.

The television set 1 performs hybrid image display in parallel, such as image and sound output of selected and received broadcast content, playback output of streaming content distributed by OTT services, playback output of visual communication such as video conference, display of graphics such as voice agents, and the like. Thus, the processing unit 11 includes a video memory with a plurality of planes including those for broadcast content, streaming content, visual communication, and graphics. When a plurality of pieces of image content are displayed simultaneously, a multi-window (multi-view) is applied. Specifically, within the processing unit 11, the resolution of each image of broadcast content, streaming content, visual communication, and graphics is converted so as to match the window size set for the image, and the resulting image is copied in a window position on each plane. Thereafter, planes in the video memory are superimposed in a predetermined order to generate one image frame, and the resulting image frame is temporarily stored in a video buffer and then displayed as an image on the display unit 14.

### «Multi-view»

The television set 1 (processing unit 11) has a multi-view function. In the multi-view processing, the processing unit 11 outputs a plurality of pieces of content in parallel from the display unit 14 and the sound output unit 16 at the same time. The types of content include: broadcast content of terrestrial broadcasting (e.g., terrestrial digital broadcasting) or satellite broadcasting (e.g., BS broadcasting, CS broadcasting) acquired via the tuner 12; external input content from a recorder and player or a game machine externally connected to a communication interface such as HDMI (registered trademark); streaming content (including UI images provided when the streaming content is distributed) distributed via the Internet by an OTT service and the like, and content such as images and sound generated by an app that does not correspond to any of the above (referred to as non-classified content).

The multi-view description of the present technology is directed to a case where two pieces of content are output in parallel, but may include a case where three or more pieces of content are output in parallel. In the description of the present technology, a multi-view in which two images are displayed in parallel on the display unit 14 as two pieces of content will mainly be described, while sound will be described as appropriate. In the following description, in relation to display on the display unit 14 such as a multi-view display, the images of content are also simply referred to as the content.

In the description of the present technology, the processing for outputting broadcast content, external input content, streaming content, and non-classified content is respectively broadcast app processing, external input app processing, streaming app processing, and non-classified app processing, regardless of whether they are executed independently of each other. In this case, the multi-view corresponds to two apps (which may include two apps of the same type) being executed in the processing unit 11 from among the broadcast app, the external input app, the streaming app, and the non-classified app. Regardless of the type of content output by the multi-view, the multi-view image itself is also one piece of content (non-classified content). The broadcast app and the external input app may be the same app.

Settings related to at least one of the images and sound of content output by the television set 1, such as settings for image quality (brightness, frame interpolation, noise removal, resolution, color, special effects, etc.) and sound quality (equalizer, etc.), are referred to as image/sound settings. The television set 1 is configured to make, in response to a specified mode corresponding to the type of content, image and sound settings with setting content determined in advance corresponding to the mode. For example, when game content is output on the television set 1, simply specifying a game mode as an image/sound setting mode achieves image/sound settings suitable for outputting the game content without performing any complicated setting operations. When the image/sound settings are made by specifying a mode, the user can specify the mode, or the television set 1 can automatically specify the mode by automatically identifying the type of content. Furthermore, when the image/sound settings are made by a mode, any type of mode can be set, and the image settings at that time can also be set with any setting content.

In the television set 1 according to the present technology, the UI is changed or set in conjunction with the image/sound settings based on a mode. For example, when the image/sound setting mode suitable for game content is set as the game mode and when the image/sound settings are set to the game mode, the UI is also set to a UI suitable for the game content. Regardless of the types of the plurality of pieces of content output in multi-view as described above, the multi-view image itself is a type of content called multi-view, and the image/sound settings are set to a multi-view mode suitable for the multi-view. At this time, the UI is also set to a UI suitable for the multi-view. However, it is not necessary to change the UI for all types of modes applied in the image/sound settings, and the UI may be changed only in a specific mode. Furthermore, regardless of whether the image/sound settings are set by a mode, the UI may be changed according to the setting content of the image/sound settings. Even in a case where the image/sound settings are set by a mode and the UI is set according to the mode, it can be said that the UI is set according to the setting content of the image/sound settings (through information called the mode).

### <Multi-view Configuration and Usage Examples>

### (Example of Viewing Two Pieces of Broadcast Content)

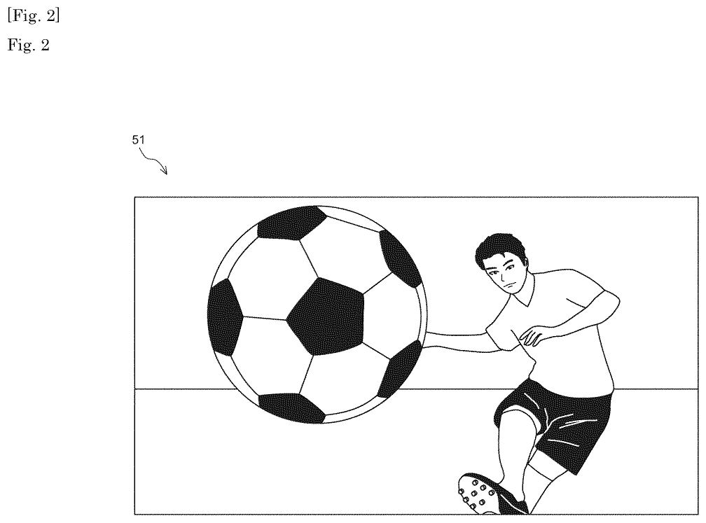

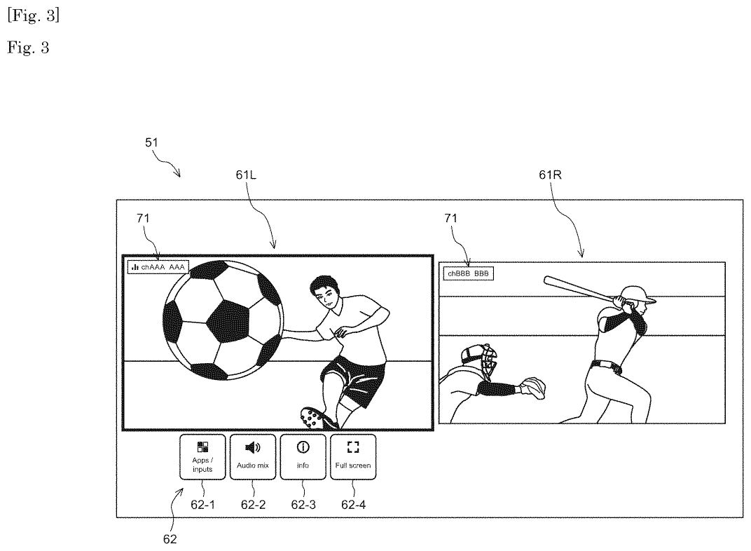

FIG. 2 illustrates a single-view image example displayed on the display unit 14, and FIG. 3 illustrates a multi-view image example displayed on the display unit 14. In FIG. 2, a screen 51 of the display unit 14 is a single-view screen including only (an image of) one piece of content, and only one piece of broadcast content such as a live broadcast of a soccer match is displayed thereon. In FIG. 3, the screen 51 of the display unit 14 is a multi-view screen including (images of) two pieces of content, and the multi-view screen has a left image display section 61L in which one piece of content is displayed and a right image display section 61R in which one piece of content is displayed. The left image display section 61L in FIG. 3 displays broadcast content such as a live broadcast of a soccer game, as in FIG. 2, and the right image display section 61R displays broadcast content such as a live broadcast of a baseball match. The arrangement of the left image display section 61L and the right image display section 61R on the multi-view screen is just an example. Specifically, on the multi-view screen, the relationship between the display positions of the two pieces of content and the relationship between their sizes are not limited to any specific case; for example, the two pieces of content may be arranged one above the other, or the sizes of the two pieces of content may be different.

The user can switch from the single-view image of FIG. 2 to the multi-view image of FIG. 3 by a specific remote controller operation. As illustrated in FIG. 3, by viewing two live images (real-time images) such as a sports broadcast in multi-view, the user can view each image without missing any crucial scenes.

In the multi-view screen of FIG. 3, content information 71 is displayed superimposed on the broadcast content in the upper left corner inside the left image display section 61L. When the content displayed in the left image display section 61L is broadcast content as illustrated in FIG. 3, this content information 71 is displayed including the channel number “AAA” (“AAA” is a predetermined number) and the name of the broadcast station “chAAA” (“chAAA” is the name of the broadcast station with the channel number “AAA”) with which the broadcast content is provided. Additionally, a sound output icon is displayed to the left of the broadcast station name “chAAA”. The sound output icon is displayed when the sound of the content indicated in the content information 71 is being output from the sound output unit 16, and is not displayed when the sound is not being output.

In the multi-view screen of FIG. 3, content information 71 is displayed superimposed on the broadcast content in the upper right corner inside the right image display section 61R. When the content displayed in the right image display section 61R is broadcast content as illustrated in FIG. 3, this content information 71 is displayed including the channel number “BBB” (“BBB” is a predetermined number) and the name of the broadcast station “chBBB” (“chBBB” is the name of the broadcast station with the channel number “BBB”) with which the broadcast content is provided. This content information 71 is displayed without the sound output icon displayed in the content information 71 of the left image display section 61L, indicating that the sound of the content displayed in the right image display section 61R is not being output.

On the multi-view screen of FIG. 3, the outline of the left image display section 61L is emphasized, indicating that the broadcast content in the left image display section 61L is focused. The user can switch the focus between the broadcast content in the left image display section 61L and the broadcast content in the right image display section 61R by a remote controller operation. A menu presentation section 62 is displayed outside and below the broadcast content in the focused left image display section 61L. The menu presentation section 62 can also be displayed by a predetermined remote controller operation. In the menu presentation section 62, icons 62-1 to 62-4 are displayed corresponding to various types of operation purposes that the user can select and execute on the multi-view screen. The position where the menu presentation section 62 is displayed is not limited. The menu presentation section 62 will be described later as appropriate.

### (Example of Viewing Broadcast Content and Streaming Content)

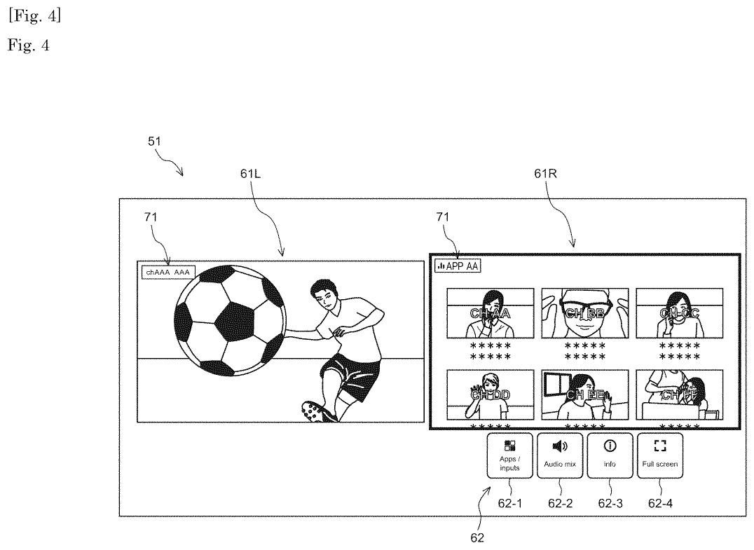

FIG. 4 illustrates a multi-view image example displayed on the display unit 14. In FIG. 4, parts common to FIG. 3 are given the same reference numerals, and description thereof will be omitted as appropriate. In FIG. 4, the screen 51 of the display unit 14 is a multi-view screen. In the left image display section 61L of the multi-view screen, broadcast content is displayed such as a live broadcast of a soccer match, as in FIG. 2. In the right image display section 61R, an image of streaming content distributed by YouTube (registered trademark) or the like (including an image of a UI provided when distributing the streaming content) is displayed.

Displaying the image of the broadcast content and the image of the streaming content in parallel in multi-view as illustrated in FIG. 4 allows the user to view other content such as streaming content until a desired scene in a TV program starts, and then immediately view the broadcast content when the desired scene comes, for example.

In the multi-view screen of FIG. 4, the content information 71 in the right image display section 61R is displayed including the name of a site (service name) providing the streaming content in the right image display section 61R, “App AA” (the name of the distributor of the streaming content displayed by executing a streaming app AA). “App AA” may indicate the name of the app AA.

On the multi-view screen of FIG. 4, the streaming content in the right image display section 61R is focused. Of the sound of the content in the left image display section 61L and the sound of the content in the right image display section 61R, the sound output from the sound output unit 16 is basically the sound of the focused content. Therefore, on the multi-view screen of FIG. 4, a sound output icon is displayed in the content information 71 in the right image display section 61R, while no sound output icon is displayed in the content information 71 in the left image display section 61L. On the multi-view screen of FIG. 4, the menu presentation section 62 is displayed outside and below the streaming content in the focused right image display section 61R.

### (Example of Viewing External Input Content and Streaming Content)

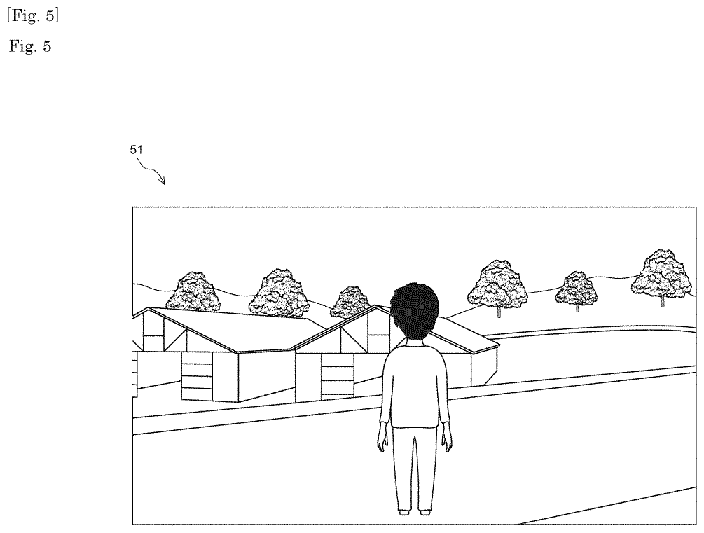

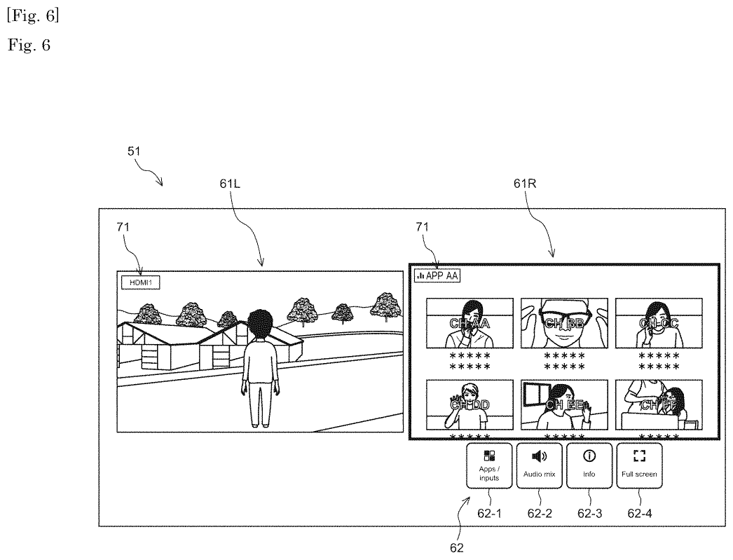

FIG. 5 illustrates a single-view image example displayed on the display unit 14, and FIG. 6 illustrates a multi-view image example displayed on the display unit 14. In FIG. 6, parts common to those in FIGS. 3 and 4 are denoted by the same reference numerals, and description thereof will be omitted as appropriate. In FIG. 5, the screen 51 of the display unit 14 is a single-view screen, and an image of external input content from a game machine is displayed thereon. In FIG. 6, the screen 51 of the display unit 14 is a multi-view screen, and in the left image display section 61L of the multi-view screen, an image of external input content from the game machine is displayed as in FIG. 5. In the right image display section 61R, streaming content is displayed as in the right image display section 61R in FIG. 4 On the multi-view screen of FIG. 6, the content in the right image display section 61R is focused, so that the menu presentation section 62 is displayed outside and below the right image display section 61R.

Displaying the image of the external input content (game content) and the image of the streaming content in parallel in multi-view as illustrated in FIG. 6 allows the user to play a game while simultaneously viewing another content on the two screens, for example.

On the multi-view screen of FIG. 6, the content information 71 in the left image display section 61L is displayed including a connector name (e.g., HDMI1) including the name of a communication interface through which the external input content is input to the television set 1. On the multi-view screen of FIG. 6, the streaming content in the right image display section 61R is focused, so that a sound output icon is displayed in the content information 71 in the right image display section 61R, while no sound output icon is displayed in the content information 71 in the left image display section 61L. On the multi-view screen of FIG. 6, the menu presentation section 62 is displayed outside and below the streaming content in the focused right image display section 61R.

### (Configuration Example of Multi-view Screen)

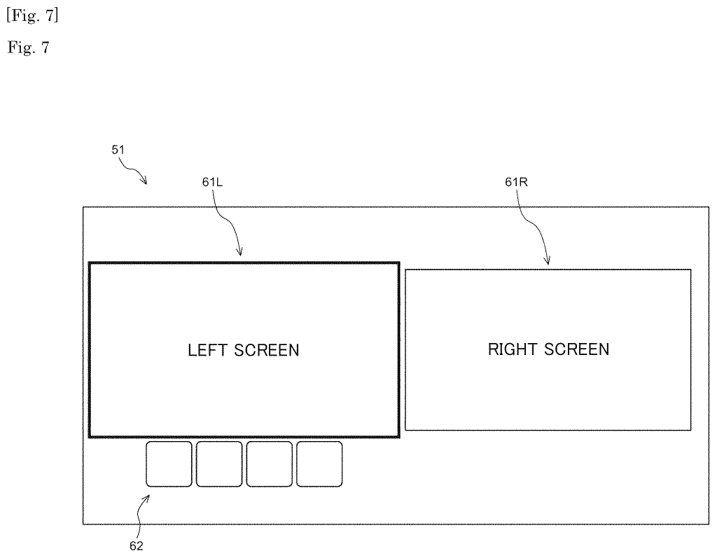

FIG. 7 is a diagram illustrating a configuration example of a multi-view screen. On the screen 51 of the display unit 14 in FIG. 7, the left image display section 61L labeled “Left Screen” and the right image display section 61R labeled “Right Screen” are arranged in multi-view. In each of the left image display section 61L and the right image display section 61R, any content (image) among broadcast content, external input content, streaming content, and non-classified content can be displayed. Therefore, a combination of any two pieces of content (which may include the same type) among these pieces of content can be displayed in the left image display section 61L and the right image display section 61R. However, there may be cases where pieces of content that can be displayed simultaneously in multi-view are limited, for example, a case where distribution of two pieces of streaming content from one distribution source to one television set 1 is not permitted.

On the multi-view screen, the user can switch the content to be focused on between the content in the left image display section 61L and the content in the right image display section 61R by a predetermined remote controller operation. The focused content is displayed, for example, larger than the other content, and the sound of the focused content is output from the sound output unit 16. The multi-view menu presentation section 62 is displayed outside and below the focused content. The user can select the icons 62-1 to 62-4 displayed on the menu presentation section 62 by a remote controller operation to perform operations on the items corresponding to the icons 62-1 to 62-4.

### <Operation Example>

### (Focus Screen Operations)

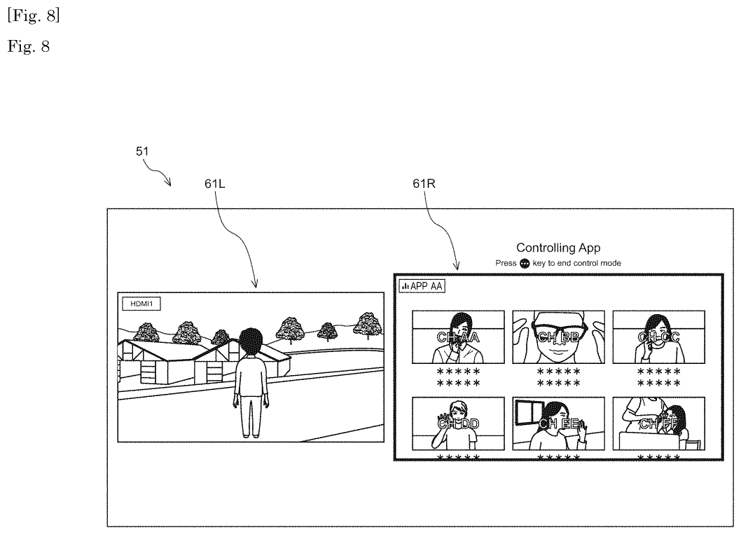

FIG. 8 illustrates a multi-view image example when performing an operation on focused content. The multi-view image example of FIG. 8 indicates a state in which the user performs a predetermined remote controller operation (e.g., an operation of pressing an Enter key) on the state of the multi-view image example of FIG. 6, enabling an operation on the focused content. In FIG. 6, the content (streaming content) in the right image display section 61R is focused, and the menu presentation section 62 is displayed outside and below the content in the right image display section 61R. In contrast, in FIG. 8, the menu presentation section 62 in FIG. 6 disappears, and a message indicating that an operation (operation in the focus screen) on the content in the focused right image display section 61R is possible is displayed outside and above the content in the right image display section 61R. The operation on the content (operation on the focus screen) is an operation on an app for outputting the content. If the content is external input content, the operation is an operation on the external input app .. If the content is streaming content, the operation is an operation on the streaming app. In other words, enabling operations within the focus screen on the multi-view screen allows the user to perform operations on the content in the same way as the same content being displayed on the display unit 14 in single view. In the example of FIG. 8, streaming content in the streaming app displayed in the right image display section 61R can be selected while maintaining the multi-view display.

### (Content Switching)

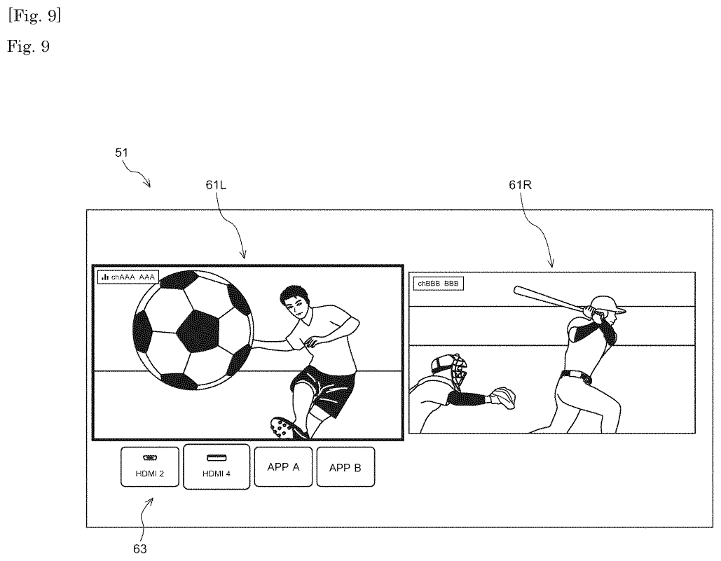

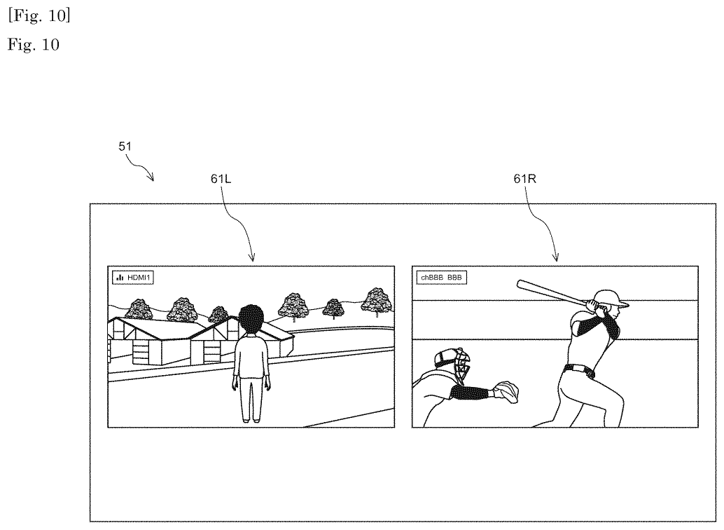

FIGS. 9 and 10 are diagrams illustrating image examples when switching between pieces of contents displayed on the multi-view screen. The multi-view image example of FIG. 9 is an image example in which the user selects (focuses and confirms) the icon 62-1 (“Apps/inputs”) in the menu presentation section 62 by a remote controller operation in the multi-view image example of FIG. 3. In FIG. 9, an app selection section 63 is displayed outside and below the broadcast content in the focused left image display section 61L. In the app selection section 63, a list of icons for an app for outputting (viewing) content to be displayed in multi-view is displayed in a scroll operation manner. In FIG. 9, only some of the external input apps are displayed with connector names by way of example, but in the app selection unit 63, icons are displayed corresponding to the broadcast app for viewing broadcast content, the external input app for viewing external input content, the streaming app for viewing streaming content, and the non-classified app for viewing other content, respectively.

The multi-view image example of FIG. 10 indicates a case where the user selects the external input app in the app selection unit 63 by a predetermined remote controller operation in the multi-view image example of FIG. 9. In the multi-view screen of FIG. 10, the content in the left image display section 61L has been switched from the broadcast content of FIG. 3 to the external input content. FIG. 10 illustrates a state in which the outline of the content in either the left image display section 61L or the right image display section 61R is not emphasized, and the sizes of the images of these pieces of content are substantially the same. Even if there is no content displayed with an outline highlighted as in FIG. 10, the content in either the left image display section 61L or the right image display section 61R may be focused inside the device. In this case, the sound of the focused content may be output inside the device, and the image of the focused content may be displayed relatively large inside the device.

On the multi-view screen, the user can switch each of the content in the left image display section 61L and the content in the right image display section 61R to the desired content, eliminating the need to go through the trouble of switching to single view first when changing either content.

### (Displaying Program Information)

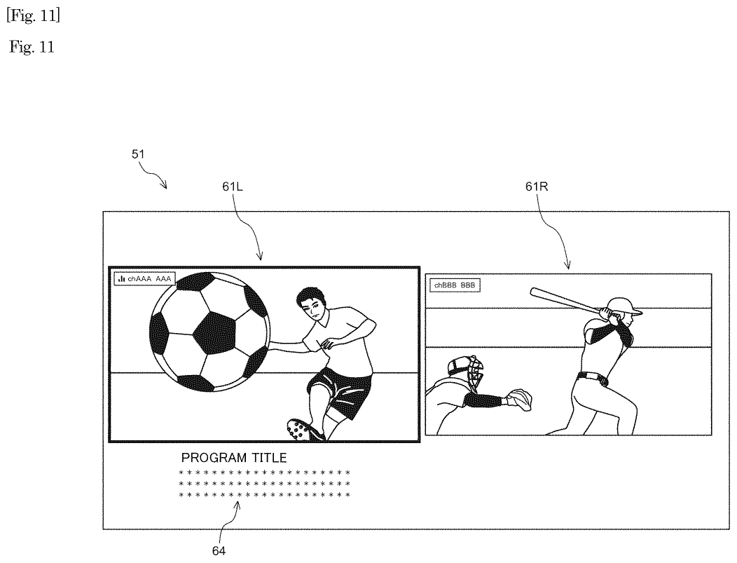

FIG. 11 illustrates a multi-view image example in which detailed information of content is displayed. The multi-view image example of FIG. 11 is an image example in which the user selects the icon 62-3 (“info”) in the menu presentation section 62 by a remote controller operation in the multi-view image example of FIG. 3. In FIG. 11, detailed information 64 is displayed outside and below the broadcast content in the focused left image display section 61L. In the detailed information 64, information related to the focused content is displayed including distribution source information (broadcast station name, etc.), title (program title, movie title, etc.), content information (plot, program description, etc.), staff information (performers, director, etc.), and time information (broadcast time, playback time, etc.).

### (Information Display On/off)

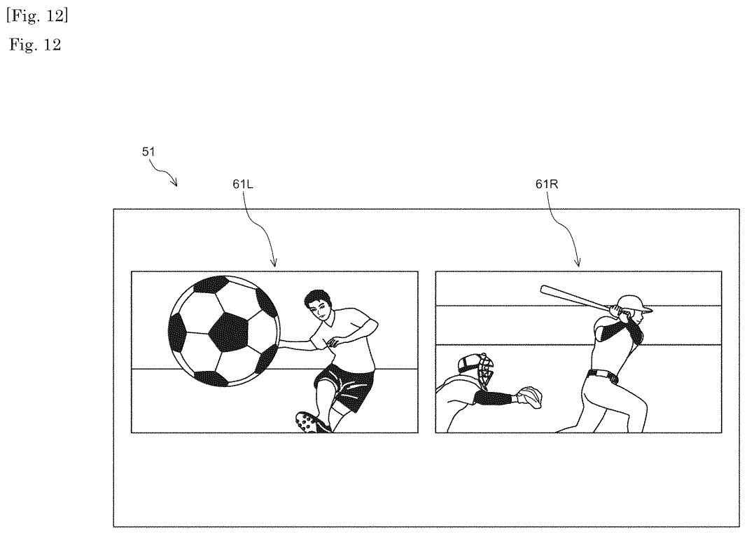

FIG. 12 illustrates a multi-view image example with information display turned off. The multi-view image example of FIG. 12 indicates a state in which information display is turned off, in contrast to the state of the multi-view image example of FIG. 3. In FIG. 12, the display of the content information 71 and the menu presentation section 62 in FIG. 3 disappears, and only the content in the left image display section 61L and the content in the right image display section 61R are displayed. Also in FIG. 12, neither the content in the left image display section 61L nor the content in the right image display section 61R is displayed with outline highlighting. When information other than the content is displayed as in FIG. 3 and for example, when the user does not perform an operation on the remote controller for a certain period of time or more, the display of information other than the content is turned off as in FIG. 12. When the information display is turned off as in FIG. 12 and when the user performs an operation on the remote controller, the display of information other than the content is turned on as in FIG. 3. Information other than the content may be included in the information displayed on the multi-view screen by turning on and off the information display. The information display may be switched on and off by a user's remote controller operation (such as an operation on a screen display on/off button).

### (Sound Output Switching)

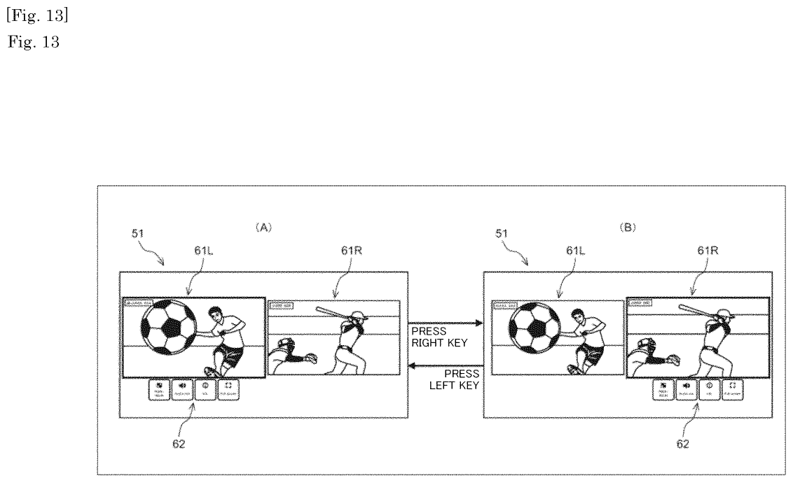

FIG. 13 is a diagram for explaining sound switching of content in multi-view. The multi-view image example in (A) of FIG. 13 is the same as the multi-view image example of FIG. 3, and therefore, detailed description thereof will be omitted. The multi-view image example in (B) of FIG. 13 indicates a state in which the broadcast content in the right image display section 61R is focused. In (B) of FIG. 13, the sound of the broadcast content in the right image display section 61R is output from the sound output unit 16.

The user can switch between a state in which the content in the left image display section 61L is focused as illustrated in (A) of FIG. 13 and a state in which the content in the right image display section 61R is focused as illustrated in (B) of FIG. 13 by a predetermined remote controller operation (operation of left and right keys). In (A) of FIG. 13, the sound of the content in the focused left image display section 61L is output from the sound output unit 16, and in (B) of FIG. 13, the sound of the content in the focused right image display section 61R is output from the sound output unit 16. Therefore, the sound of the content output from the sound output unit 16 is switched in conjunction with the switching of the focus. The focused content is displayed in a larger size than the other content.

### (Simultaneous Sound Output)

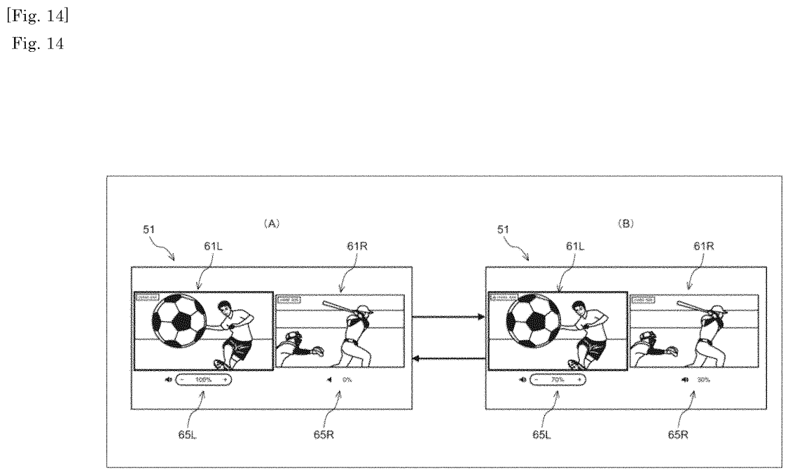

FIG. 14 illustrates a multi-view image example in which a setting screen for sound output is displayed. The multi-view image example of FIG. 14 is an image example in which the user selects the icon 62-2 (“Audio mix”) in the menu presentation section 62 by a remote controller operation in the multi-view image example of FIG. 3. In (A) of FIG. 14, volume setting sections 65L and 65R for setting or changing the volume balance are displayed outside and below the content of the left image display section 61L and the content of the right image display section 61R (left and right pieces of content), respectively. The volume setting sections 65L and 65R display the ratio (sound mixing ratio) of the sound of the left and right contents to the sound (output sound) output from the sound output unit 16. As the initial value of the volume balance, the sound mixing ratio of the focused left content is 100%, and the sound mixing ratio of the right content is 0%, as illustrated by way of example in the volume setting sections 65L and 65R in (A) of FIG. 14. When the user changes the sound mixing ratio of the focused left content by a predetermined remote controller operation, the sound mixing ratio of the right content is changed in conjunction with the change. In (B) of FIG. 14, the sound mixing ratio of the left content is changed to 70% as illustrated by way of example in the volume setting section 65L, and the sound mixing ratio of the right content is changed to 30% as illustrated by way of example in the volume setting section 65R. In this way, when the sound of both the left and right pieces of contents is mixed to be output to generate output sound, the output sound may be output with the sound balance set by the volume setting sections 65L and 65R only when neither the left nor the right content is focused. Without being limited to this, when the left content is focused as in (A) of FIG. 13, for example, output sound with a sound mixing ratio of the left content of 70% and a sound mixing ratio of the right content of 30% may be output from the sound output unit 16, and when the right content is focused as in (B) of FIG. 13, for example, output sound with the sound mixing ratios of the left and right pieces of content inverted may be output from the sound output unit 16.

(Switching from Multi-view to Single-view)

In the multi-view image example of FIG. 3, when the user selects the icon 62-4 (“Full screen”) in the menu presentation section 62 by a remote controller operation, the content in the left image display section 61L is switched to full screen display (single-view).

### «UI Other Than Multi-view»

In the television set 1 according to the present technology, the image/sound settings of content to be displayed on the display unit 14 can be made by setting to content previously set by the user corresponding to a mode by specifying the mode according to the type of the content, or by setting to preset content. When the image/sound settings are made in the mode corresponding to the type of the content, the mode is also referred to as the content mode. The type of content (type of mode) when the image/sound settings are made in the content mode is not limited to only the type according to the content provider such as the above-described broadcast content (broadcast mode), external input content (external input mode), streaming content (streaming mode), and non-classified content (non-classified mode), but can be freely set such as broadcast content (broadcast mode), game content by external input of a game machine, a game app, or the like (game mode), video content by external input of a recorder and player, a Video On Demand (VOD) app, or the like (video mode), PC content generated by a personal computer (PC) (PC mode), a multi-view image (multi-view mode), and the like.

In the television set 1 according to the present technology, a UI for the user to select and execute an operation of any one of operational items from among operations for various types of operation purposes (various types of operational items) that the user can perform through information on the display unit 14 is changed according to the image/sound setting mode in which the image/sound settings are made in the content mode. As the UI, there is a UI (menu UI) such as the menu presentation section 62 in multi-view that presents operational items that the user can select and execute.

In particular, in the present technology, the UI when the image/sound setting mode is the game mode differs at least visually from the UI when it is the multi-view mode, both in terms of visual and operational items, and in particular the menu UI differs between the game mode and the multi-view mode. When the image/sound setting mode is a mode other than the game mode and the multi-view mode, a common UI may be used, or the difference may be such that the operational items presented in the menu UI differ depending on the image/sound setting mode.

### Example of Menu UI When Image/Sound Setting Mode is Other Than Game Mode>

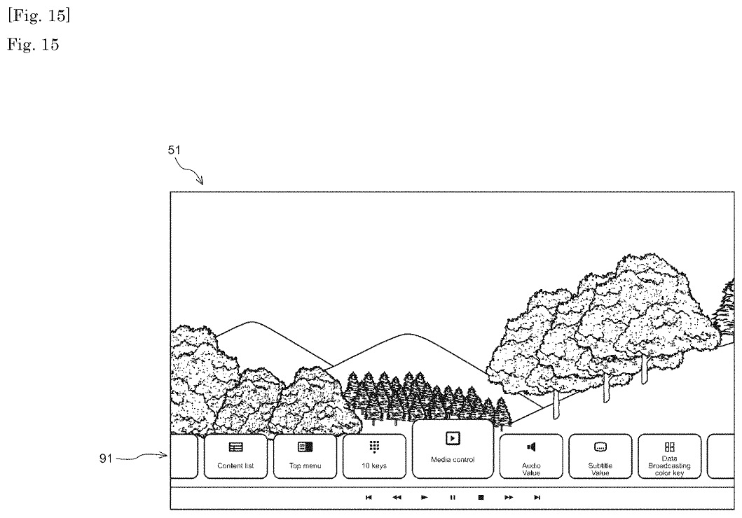

FIG. 15 illustrates a single-view image example in which content is displayed on the display unit 14 when the image/sound setting mode is not the game mode. One piece of external input content such as scenery is displayed on the screen 51 of the display unit 14 in FIG. 15. This external input content is, for example, content transmitted from a recorder and player to the television set 1 via a communication interface such as HDMI (registered trademark). When the external input content is game content from a game machine or the like, information indicating that the content is a game is provided to the television set 1 together with the external input content, and therefore, depending on the presence or absence of that information, it can be recognized whether the external input content is game content or not.

In response to the user performing a predetermined remote controller operation, a menu presentation section 91 is displayed as a menu UI at the bottom inside of the screen 51, superimposed on the external input content. In the menu presentation section 91, icons are displayed corresponding to operational items such as “Content list”, “Top Menu”, “10 keys”, “Media control”, “Audio Value”, and “Subtitle Value”. The image example of FIG. 15 can be determined as the external input content being content played on a medium by a recorder and player. In this case, the image/sound setting mode is set to, for example, an external input mode corresponding to the external input content or a video mode corresponding to video content, and the menu presentation section 91 is also displayed in a UI for the image/sound setting mode. When detailed information on the type of content as well as the image/sound setting mode is obtained, a UI such as a media control bar can be displayed based on that information.

### <Example of Menu UI When Image/Sound Setting Mode is Game Mode>

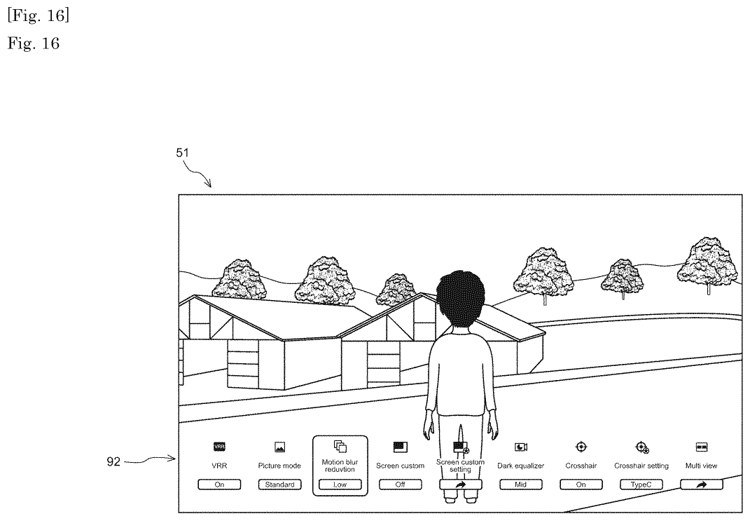

FIG. 16 illustrates a single-view image example in which content for which the image/sound setting mode is the game mode is displayed on the display unit 14. On the screen 51 of the display unit 14 in FIG. 16, an image of the external input content from the game machine is displayed, similar to the external input content illustrated in FIG. 5. The fact that the external input content in FIG. 16 is game content can be recognized by the fact that information indicating that the content is a game is provided from the game machine together with the external input content. As a result, the image/sound setting mode becomes the game mode, and the image/sound settings are made according to the setting content corresponding to the game content accordingly. In the game mode, settings other than the image/sound settings may also be set to settings corresponding to the game content.

When the user performs a predetermined remote controller operation, a menu presentation section 92 as a menu UI is displayed at the bottom inside of the screen 51, superimposed on the external input content. The menu presentation section 92 is displayed in a UI for the game mode, which is an image/sound setting mode. In the menu presentation section 92, icons are displayed corresponding to operational items specialized for game content, such as “VRR”, “Picture Mode”, “Motion blur reduction”, “Screen custom”, “Screen custom setting”, “Black equalizer”, “Crosshair”, and “Crosshair setting”, and their current setting content (excluding some operational items). The menu presentation section 92 has a different icon design (color, shape, etc.) from other image/sound setting modes, at least the multi-view mode.

### <Example of UI for Screen Size and Position When Image/sound Setting Mode is Game Mode>

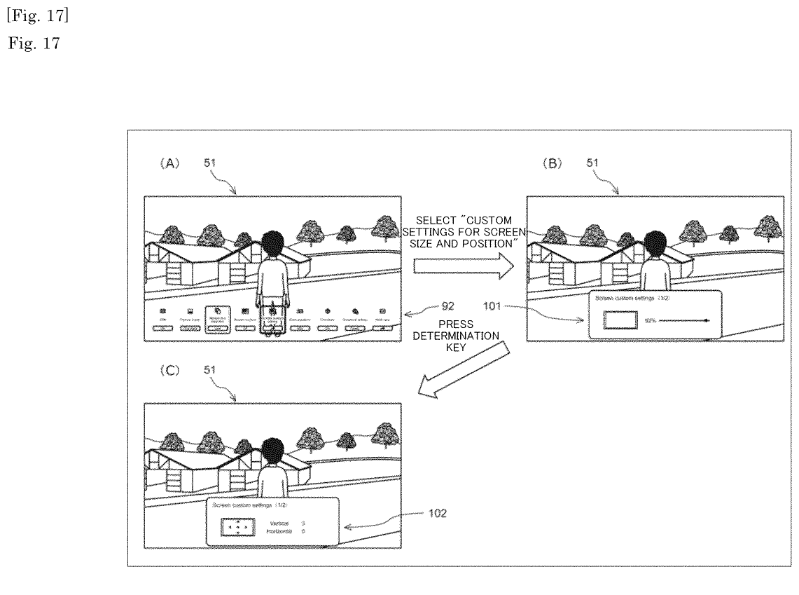

FIG. 17 is a diagram illustrating an example of a UI for operating the screen size and position that are allowed to be operated when the image/sound setting mode is the game mode. In FIG. 17, (A) illustrates the screen 51 of an image of external input content, which is game content, as in FIG. 16. When the user selects (focuses and confirms) an icon “Screen custom setting” in the menu presentation section 92 displayed at the bottom inside of the screen 51 by a predetermined remote controller operation, the image of the screen 51 of (B) in FIG. 17 is displayed. In (B) of FIG. 17, a screen size setting section 101 is displayed at the bottom inside of the screen 51, allowing the user to perform an operation of adjusting the screen size of the external input content. In the screen size setting section 101, for example, a slider is displayed, and the user can adjust the screen size in 1% increments within the range of 0% to 100% by moving the slider by a remote controller operation. For a screen size of 100%, it is the maximum screen size that allows the entire image of the external input content to be displayed within the range of the screen 51 of the display unit 14. When the user confirms the screen size by a predetermined remote controller operation, the image of the screen 51 in (C) of FIG. 17 is displayed. In (C) of FIG. 17, a screen position setting section 102 is displayed, which allows the user to perform an operation of adjusting the screen position of the external input content. The user can adjust the display position of the external input content within the range of the screen 51 of the display unit 14 in the vertical and horizontal directions in increments of 10 dp by a predetermined remote controller operation on the screen position setting section 102. When the user confirms the screen position by a predetermined remote controller operation, the display of the image of the external input content on the screen 51 is switched to display with the size and position set in the screen size setting section 101 and the screen position setting section 102.

Changing the size and position of the screen makes it possible to adjust the display range of the image of content to an appropriate size when, for example, the screen of the display unit 14 is too large. When the screen size is reduced, the position on the screen of the display unit 14 where the image of content is to be displayed can also be adjusted, thereby making it possible to avoid situations where the image is difficult to see due to, for example, reflections of illumination light or high-brightness objects on the screen. The television set 1 may use the imaging unit 17 to determine the viewer's line of sight, face position, and the like, and automatically adjust the size and position of the screen.

### <UI of App for Outputting Content for Which Image/sound Setting Mode is Game Mode>

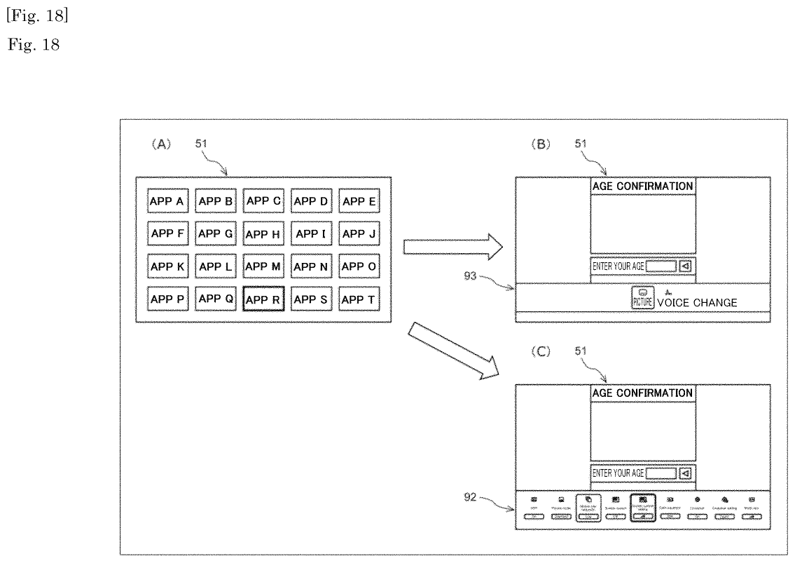

The UI (UI for game content) when the image/sound setting mode is the game mode as illustrated in FIGS. 16 and 17 is not limited to the case where the external input content from a game machine or the like is game content. FIG. 18 is a diagram for explaining an app to which the UI when the image/sound setting mode is the game mode is applied. In FIG. 18, (A) is a home menu displayed on the screen 51 of the display unit 14 by a user's remote controller operation, and a list of icons for various applications is displayed on the home menu. The apps to be displayed on the home menu include broadcasting apps, external input apps, streaming apps, non-classified apps, and the like. When any app on the home menu is selected by a user's predetermined remote controller operation and when the app is not an app specified as a game app, a general-purpose menu presentation section 93 is usually displayed on the screen 51 of the display unit 14 as illustrated in (B) of FIG. 18. On the other hand, when an app specified as a game app is selected, the menu presentation section 92 as a UI for game content is displayed on the screen 51 of the display unit 14 as illustrated in (C) of FIG. 18. Even for a non-classified app displaying the general-purpose menu presentation section 93 in (B) of FIG. 18 as a default, if it is registered as an app specified as a game app, the menu presentation section 92 as a UI for game content will be displayed, as illustrated in (C) of FIG. 18, in response to the app specified as a game app being selected. The specification as a game app may be performed by the creator or distributor of the app, or may be performed manually by the user. The television set 1 may determine the content of an app and automatically specify the app as a game app depending on the content.

Even if the image/sound settings are not set by a mode, the UI can be changed according to the setting content of the image/sound settings. In this case, if it is determined that the image/sound settings correspond to game content, a UI for game content may be applied. In other words, the present technology can employ either a method of setting a UI according to the image/sound setting mode, or a method of setting a UI according to the setting content of the on the assumption that the former is employed.

When game content is output in multi-view, even if an operation on the game content (operation on the focus screen) becomes possible as described with reference to FIG. 8, the image/sound setting mode is the multi-view mode, so that a UI for game content is not applied. However, if an operation on the game content (operation on the focus screen) becomes possible in multi-view, a UI for the image/sound setting mode that would be applied in single view may be applied only to that game content, regardless of the image/sound setting mode. The same applies when content that is allowed to be operated within the focus screen in multi-view is other than game content.

### «Example of Camera App»

### <Operation Description>

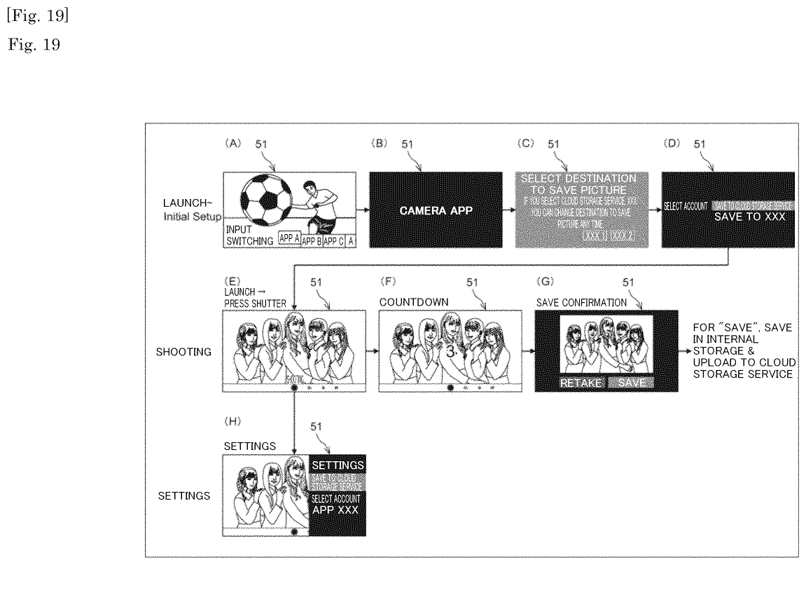

FIG. 19 is an explanatory diagram for explaining an operation of a camera app .. The camera app shoots an image of a person or the like in front of the display unit 14 with the imaging unit 17 (hereinafter, referred to as the camera 17) of the television set 1 in FIG. 1 and saves the shot image thus shot. According to this camera app, a picture (shot image) can be taken with the camera 17 mounted on the television set 1. The taken picture can be viewed on the display unit 14 of the television set 1. Furthermore, the taken picture can be automatically saved to a cloud storage service or the like.

In (A) of FIG. 19, when the user launches the camera app by a predetermined remote controller operation, a message that the camera app has been launched is displayed on the screen 51 of the display unit 14 as in (B) of FIG. 19. After that, as in (C) of FIG. 19, a screen for selecting a destination to save the shot image (picture) is displayed on the screen 51. As selectable destinations to save, for example, cloud storage services and the inside of the television set 1 (internal storage) are displayed. For example, if the user selects a cloud storage service as a destination to save the shot image, then as in (D) of FIG. 19, a screen for selecting an account for using the cloud storage service is displayed on the screen 51. The user registers the account in advance. When the account is selected, then as in (E) of FIG. 19, the live view shot by the camera 17 starts to be displayed on the screen 51. In addition to a shooting button, a setting button for making various settings is displayed on the screen 51. The user selects the shooting button or the setting button by a remote controller operation, and for example, by selecting the setting button, a setting screen is displayed as in (H) of FIG. 19. On the setting screen, the user can change the destination to save the shot image, and the like. In (E) of FIG. 19, when the user selects the shooting button, a countdown starts as illustrated in (F) of FIG. 19. When the countdown starts, then, for example, after 3 seconds, a white image (high-brightness image) is momentarily displayed on the entire screen 51 of the display unit 14, and the screen 51 illuminates (flashes) the subject. Still image shooting (shutter release) is executed in synchronization with the illumination of the subject. After the still image shooting, the shot image is displayed on the screen 51 as illustrated in (G) of FIG. 19, and the user is asked whether to retake the image or save the shot image. When the user selects to retake the image by a remote controller operation, the screen returns to the screen 51 of (E) of FIG. 19, and the user starts over by an operation on the shooting button. In (G) of FIG. 19, when the user selects to save the shot image, the shot image is saved in the internal storage, which is the destination to save selected by the user, or the shot image is uploaded to a cloud storage service.

### <Processing Procedure>

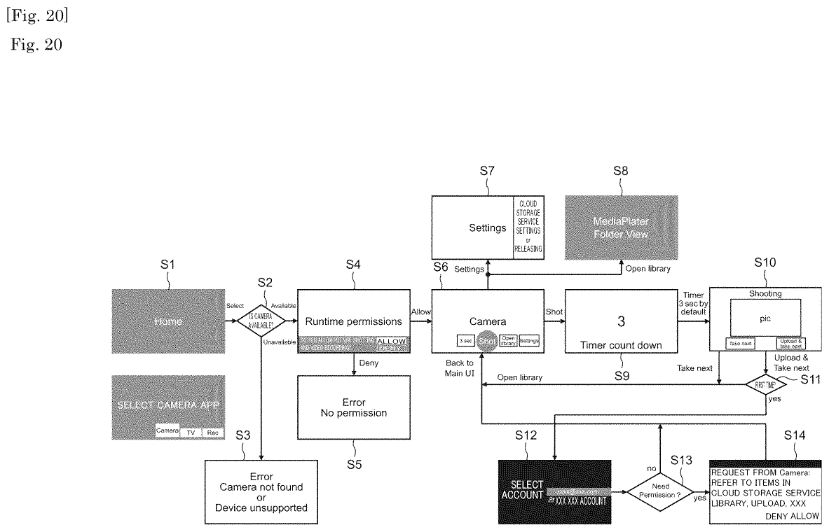

FIG. 20 is a flowchart illustrating a processing procedure of the camera app. In step S1, the camera app is launched by a user's remote controller operation on the home menu screen or the like on the screen 51 of the display unit 14. In step S2, the camera app determines whether or not the camera 17 is available. If the result in step S2 is unavailable, the processing proceeds to step S3, and then the processing of the camera app ends due to an error. If the result in step S2 is available, the processing proceeds to step S4, and then the camera app inquires of the user whether or not to permit shooting and recording with the camera. If the result in step S4 is deny, the processing proceeds to step S5, and then the processing of the camera app ends. If the result in step S4 is allow, the processing proceeds to step S6, and then the camera app displays the screen of (E) of FIG. 19 on the screen 51 of the display unit 14. In step S6, if the setting button is selected, the processing proceeds to step S7, and then the camera app makes settings in accordance with a user's remote controller operation. In step S6, if the user selects, by a remote controller operation, browsing of a save folder in which previously shot images have been saved, the processing proceeds to step S8, and then a shot image in the save folder is reproduced and displayed on the screen 51.

In step S6, the camera app starts a countdown as illustrated in (F) of FIG. 19. When three seconds have elapsed since the camera app started the countdown, the processing proceeds to step S10. In step S10, the camera app shoots a still image using the camera 17, displays the shot image on the screen 51 as illustrated in (G) of FIG. 19, and asks the user whether to retake or save the image. In step S10, if the user selects to retake the image, the processing returns to step S6, and then the camera app repeats the processing from step S6. If the user selects to save the image in step S10, the processing proceeds to step S11. In step S11, the camera app determines whether or not the retake is the first time. In other words, in step S11, it is determined whether the processing required for saving the shot image, which is performed in steps S12 to S14, have already been performed. If the result in step S11 is yes, the processing proceeds to step S12, and then the camera app acquires an account for the destination to save selected by the user (if the destination to save is a cloud storage service). In step S13, the camera app determines whether or not permission is required for the camera 17 to upload the shot image to the destination to save, to refer to a library in the destination to save, and so on. If the result in step S13 is yes, the processing proceeds to step S14, and then the camera 17 requests permission to upload the shot image to the destination to save, and so on. If the user permits the request from the camera 17, the camera app saves the shot image in the destination to save set by the user, and then repeats the processing from step S6. If the result in step S13 is no, the camera app saves the shot image in the destination to save set by the user, and then repeats the processing from step S6. If the result in step S11 is no, the camera app saves the shot image in the destination to save set by the user, and then repeats the processing from step S6.

### <Advantages of Camera App>

Users gathered in front of the television set 1 at a party or family event can take a selfie immediately by simply operating the television set 1 without setting up equipment such as a mobile or a tripod. A user who has taken a selfie in front of the television set 1 can immediately view the selfie on the large screen of the television set 1 together with the subject users of the selfie. The user who has taken the selfie in front of the television set 1 can easily share the selfie with the subject users. The camera app can perform the same processing as single view by using one of the screens of multi-view. The flash for displaying a high-brightness image on the screen when the shutter is released may be limited to the screen range used by the camera app, or a high-brightness image may be displayed on the entire screen of the display unit 14 only at the flash when the shutter is released.

### «Program Information Screen Configuration and Operation Examples»

### <Example of Favorites Screen>

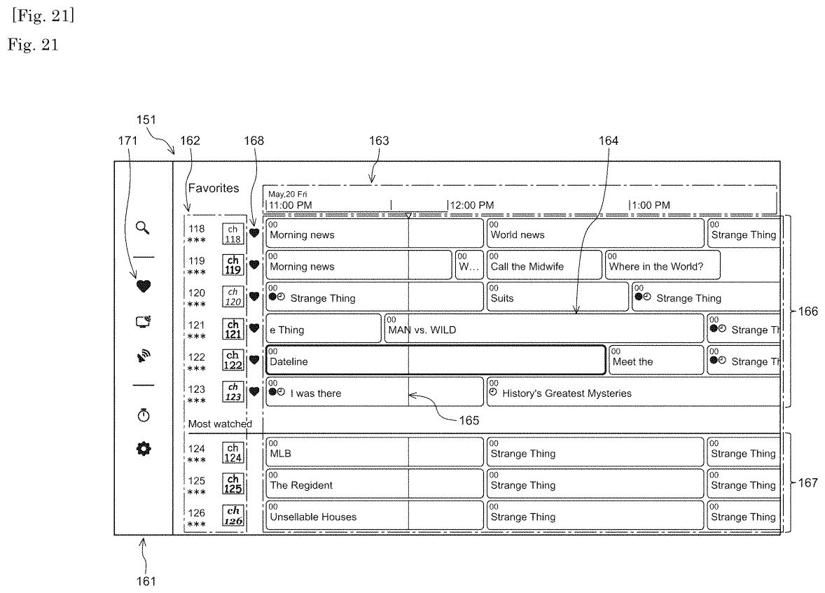

FIG. 21 illustrates a display example of a program information screen for television broadcasts (terrestrial broadcasts and satellite broadcasts) on the television set 1. In FIG. 21, a program information screen 151 is displayed on the screen 51 of the display unit 14 by a user's predetermined remote controller operation. The program information screen can also be displayed on a screen that displays one image in multi-view. The program information screen 151 has a menu field 161, a channel field 162, a time field 163, a program field 164, a current time indicator line 165, a favorite channel section 166, a most watched channel section 167, and a favorite mark section 168. Icons for selecting a method for displaying program information are displayed in the menu field 161, and when a heart mark icon 171 is selected by a user's remote controller operation, program information of a favorite channel is displayed in the program field 164, as on the program information screen 151.

In the channel field 162, channel numbers and logos of favorite channels (broadcast stations) and most watched channels are arranged vertically. If the direction in which the channel numbers are arranged is called the channel direction, the vertical direction is the channel direction. In the figure, three-digit numbers are examples of channel numbers, and a notation part with the letter “ch” added to the upper side of each channel number to the right of the channel number indicates the logo (channel logo) of that channel number (broadcast station). In the time field 163, assigned time is displayed along a horizontal time axis. If the direction of the time axis is called the time direction, the horizontal direction is the time direction. In the program field 164, the title of a program to be broadcast at the time of day in the time field 163 on the corresponding channel in the channel field 162, the start time of the program, and so on are displayed as program information. When a display area of a specific program in the program field 164 is selected (or focused), the display area is enlarged or a pop-up window is displayed, and detailed information of the selected program is displayed. The current time indicator line 165 indicates the position in the program field 164 that corresponds to the current time. The favorite channel section 166 indicates a range in which favorite channels and their program information are displayed in the channel field 162 and the program field 164. A favorite channel is a channel that the user has previously set as a favorite. The most watched channel section 167 indicates a range in which most watched channels and their program information are displayed in the channel field 162 and the program field 164. The most viewed channels are channels that are frequently viewed and are calculated based on the user's previously viewing history. The favorite mark section 168 is a section to the right of the channel field 162 where a heart mark, which is a favorite mark, is displayed for a favorite channel.

According to the program information screen 151 of FIG. 21, program information of most watched channels is displayed immediately below the favorite channel section 166 in which the program information of favorite channels is displayed. Thus, channels that are most watched and are likely to be registered as favorite channels can be easily registered as favorite channels.

On the program information screen 151, for example, the upper ⅔ range may be fixed as the range of the favorite channel section 166, and the lower ⅓ range may be fixed as the range of the most watched channel section 167. When all of the favorite channels cannot be displayed simultaneously in the favorite channel section 166, only some favorite channels may be scrolled within the range of the favorite channel section 166 by the user performing a scroll operation. Alternatively, most watched channels may be displayed below all favorite channels. On the program information screen 151, program information may be displayed with the vertical direction representing the time direction and the horizontal direction representing the channel direction.

### (First Form of Fast Scrolling on Program Information Screen)

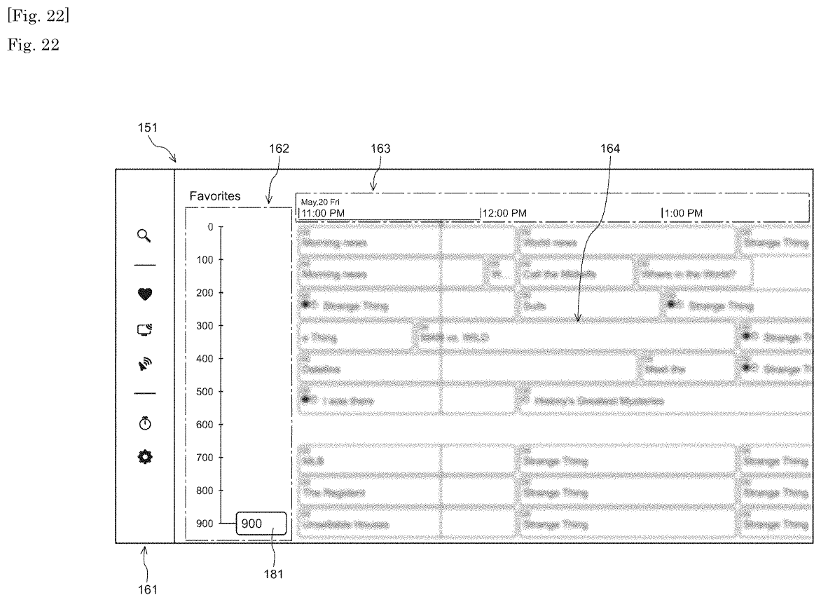

FIG. 22 is a diagram for explaining a first form of high-speed scrolling in the vertical direction (channel direction) on the program information screen 151 of FIG. 21. In the figure, parts common to FIG. 21 are given the same reference numerals, and description thereof will be omitted. For example, when the user performs a predetermined remote controller operation such as a long press of the up key or the down key of a cross key of the remote controller on the program information screen 151 of FIG. 21, a vertical high-speed scroll mode is entered, and the program information screen 151 of FIG. 22 is displayed accordingly. In the channel field 162 on the program information screen 151 of FIG. 22, displayed are a vertical ch scale line (vertical axis) to which channel numbers from 0, which is the minimum number of the channel, to 900, which is the maximum number of the channel, are assigned, and a selected channel display section 181 that moves vertically along the ch scale line. For example, in the high-speed vertical scroll mode, when the user performs a downward scroll operation by a remote controller operation, the selected channel display section 181 moves downward (or upward). In the selected channel display section 181, the channel number of the ch scale line corresponding to its position is displayed as the selected channel number. When the user stops the high-speed scrolling operation, program information of the neighboring channel numbers centering around the selected channel number at that time is displayed in the program field 164.

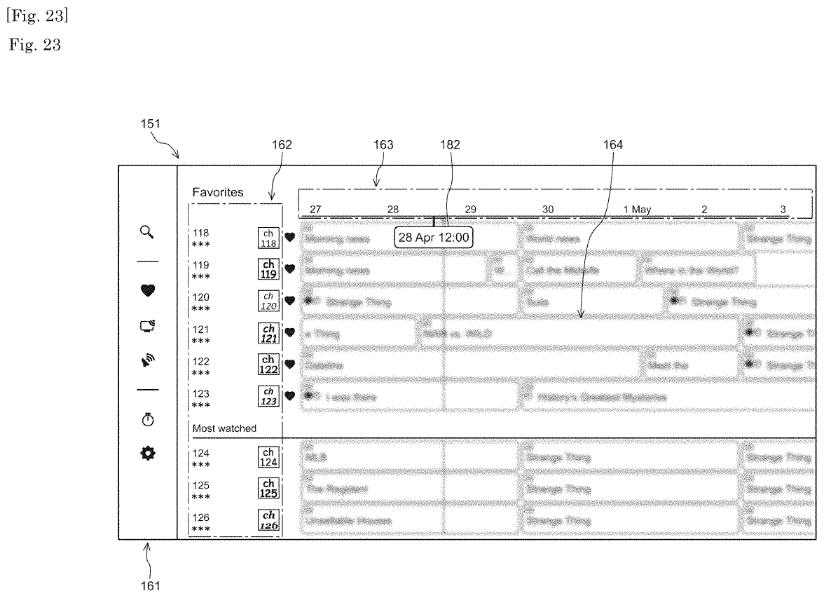

Note that FIG. 22 is a screen on which program information of favorite channels is displayed as in FIG. 21, and when high-speed vertical scrolling is performed, the selected channel display section 181 may move over only the positions of the channel numbers of the favorite channels, or the selected channel display section 181 may move over the positions of all channel numbers. Similarly, high-speed scrolling can be performed on the program information screen on which program information of all channels or a number of channels that cannot be displayed on one screen is displayed, instead of program information of favorite channels. Also in the following FIGS. 23 to 25, similarly, the high-speed scrolling is not limited to that for favorite channels.

FIG. 23 is a diagram for explaining a first form of high-speed scrolling in the horizontal direction (time direction) on the program information screen 151 of FIG. 21. In the figure, parts common to FIG. 21 are given the same reference numerals, and description thereof will be omitted. For example, when the user performs a predetermined remote controller operation such as a long press of the left key or the right key of the cross key of the remote controller on the program information screen 151 of FIG. 23, a horizontal high-speed scroll mode is entered, and the program information screen 151 of FIG. 23 is displayed accordingly. In the time field 163 on the program information screen 151 of FIG. 23, the time range assigned to the time axis is expanded compared to the program information screen 151 of FIG. 21. For example, the time range assigned to the time axis on the program information screen 151 of FIG. 21 is about three hours, whereas the time range assigned to the time axis on the program information screen 151 of FIG. 23 is expanded to about six days. The time range in the high-speed scroll mode may be determined based on the number of days for which program information can be acquired. In addition, a selected time display section 182 that moves along the time axis is displayed below the time axis. For example, in the horizontal high-speed scroll mode, when the user performs a rightward scroll operation by a remote controller operation, the selected time display section 182 moves rightward (or leftward). In the selected time display section 182, the time of day on the time axis corresponding to that position is displayed as the selected time of day. When the user stops the high-speed scrolling operation, program information of the neighboring times of day centering around the selected time at that time is displayed in the program field 164.

### (Second Form of Fast Scrolling on Program Information Screen)

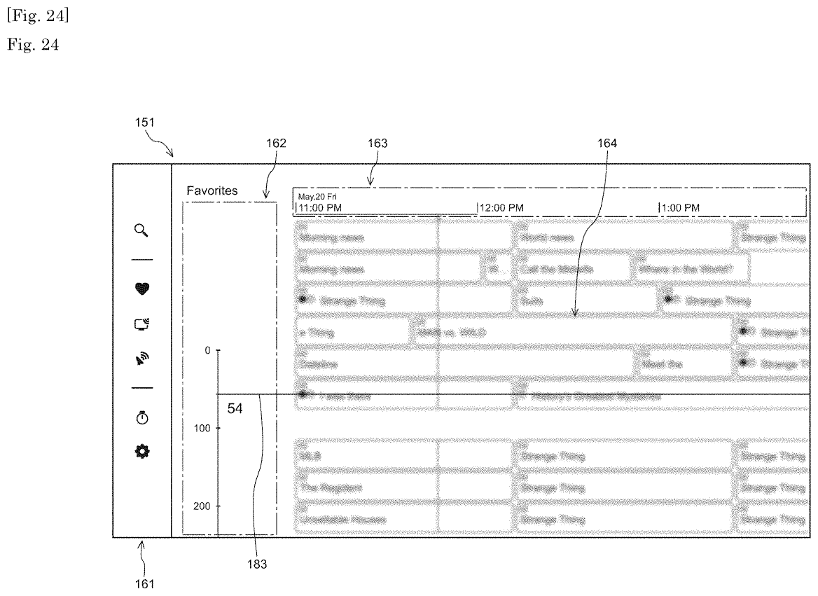

FIG. 24 is a diagram for explaining a second form of high-speed scrolling in the vertical direction (channel direction) on the program information screen 151 of FIG. 21. In the figure, parts common to FIG. 21 are given the same reference numerals, and description thereof will be omitted. For example, when the user performs a predetermined remote controller operation such as a long press of the up key or the down key of a cross key of the remote controller on the program information screen 151 of FIG. 21, a vertical high-speed scroll mode is entered, and the program information screen 151 of FIG. 24 is displayed accordingly. In the channel field 162 on the program information screen 151 of FIG. 24, displayed are a vertical ch scale line (vertical axis) to which channel numbers from 0, which is the minimum number of the channel, to 900, which is the maximum number of the channel, are assigned, and a horizontal ch indicator line 183 that indicates a position on the ch scale line, relative to the ch scale line. The position of the ch indicator line 183 on the screen is fixed. For example, in the vertical high-speed scroll mode, when the user performs a downward scroll operation by a remote controller operation, the ch scale line move downward (or upward). In the vicinity of the ch indicator line 183, the channel number of the ch scale line pointed to by the ch indicator line 183 is displayed as the selected channel number. When the user stops the high-speed scrolling operation, program information of the neighboring channel numbers centering around the selected channel number at that time is displayed in the program field 164.

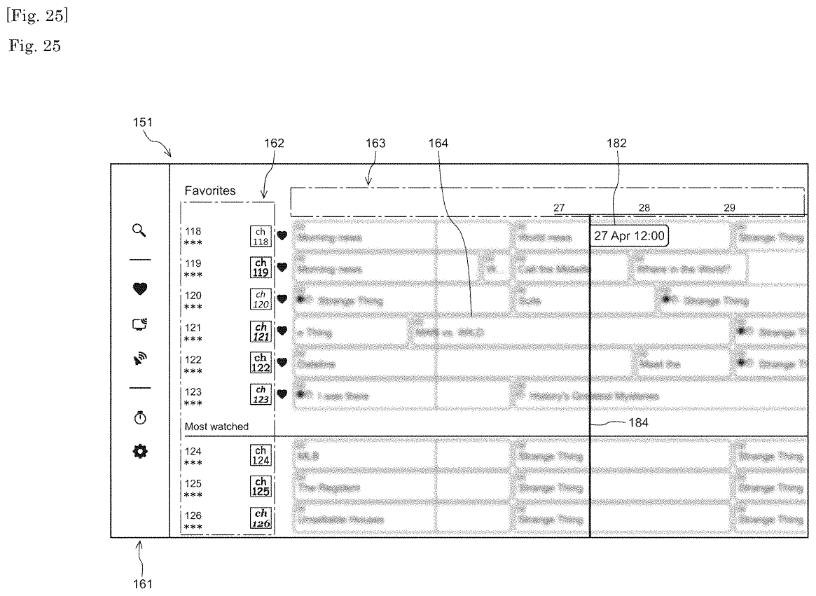

FIG. 25 is a diagram for explaining a second form of high-speed scrolling in the horizontal direction (time direction) on the program information screen 151 of FIG. 21. In the figure, parts common to FIG. 21 are given the same reference numerals, and description thereof will be omitted. For example, when the user performs a predetermined remote controller operation such as a long press of the left key or the right key of the cross key of the remote controller on the program information screen 151 of FIG. 25, a horizontal high-speed scroll mode is entered, and the program information screen 151 of FIG. 25 is displayed accordingly. In the time field 163 on the program information screen 151 of FIG. 25, the time range assigned to the time axis is expanded compared to the program information screen 151 of FIG. 21. For example, similar to the time axis of the program information screen 151 of FIG. 23, the time axis of the program information screen 151 of FIG. 25 is expanded to about six days. In addition, an indicator line 184 that indicates a position on the time axis is displayed, relative to the time axis. For example, in the horizontal high-speed scroll mode, when the user performs a rightward scroll operation by a remote controller operation, the time axis moves to the right (or left). In the selected time display section 182, the time of day on the time axis corresponding to the position indicated by the indicator line 184 is displayed as the selected time of day. When the user stops the high-speed scrolling operation, program information of the neighboring times of day centering around the selected time at that time is displayed in the program field 164.

### «Displaying Program Information»

### <First Display Form of Program Information>

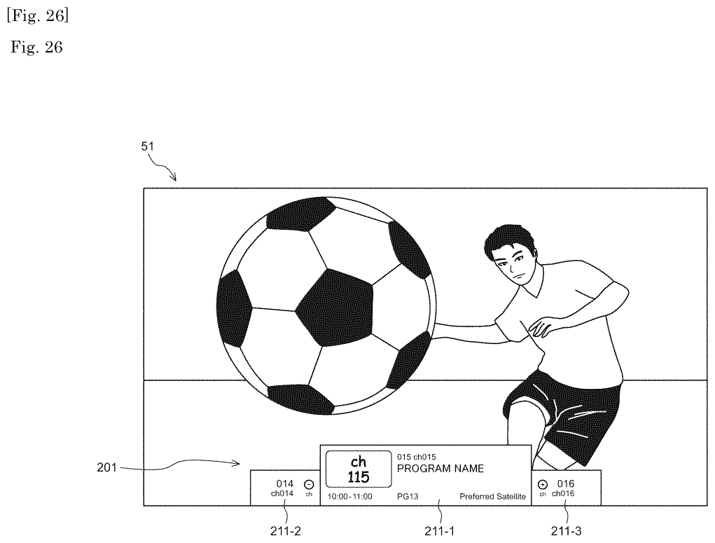

FIG. 26 is a diagram illustrating a first display form of program information superimposed on an image of broadcast content in the television set 1. In FIG. 26, broadcast content is displayed on the screen 51 of the display unit 14 as in FIG. 2. When the broadcast content is displayed in single-view, a UI for the broadcast content is applied to the information display (program information, menu, etc.) on the screen 51. The broadcast content can be output as multi-view content. In this case, even if an operation on the broadcast content (operation on the focus screen) becomes possible as described in FIG. 8, the image/sound setting mode is the multi-view mode, so that a UI for broadcast content is not applied. However, when an operation on the broadcast content (operation on the focus screen) becomes possible in multi-view, a UI for the image/sound setting mode that would be applied in single view may be applied only to that broadcast content, regardless of the image/sound setting mode.

In FIG. 26, when the user performs a predetermined remote controller operation (e.g., a +/− channel selection operation), a program information presentation section 201 is displayed at the bottom inside of the screen 51, superimposed on the image of the broadcast content. Pieces of program information 211-1, 211-2, and 211-3 are displayed in the program information presentation section 201. In the program information 211-1, information is displayed such as the broadcast station name, channel number, program name, and broadcast time of the broadcast content currently displayed on the screen 51. In the figure, a three-digit number represents a channel number, and a character string with the letter “ch” added to the number (e.g., “ch115”) indicates information corresponding to the channel number, such as the broadcast station name or channel logo. In the program information 211-2, displayed are the channel number, the broadcast station name, and so on when the channel is switched to the channel previous to the current channel by a remote controller operation. In the program information 211-3, displayed are the channel number and the broadcast station name when the channel is switched to the channel next to the current channel by a remote controller operation. According to the program information presentation section 201 in FIG. 26, during +/− channel selection, the previous and next pieces of channel information are displayed, making it easier to select a channel.

### <Second Display Form of Program Information>

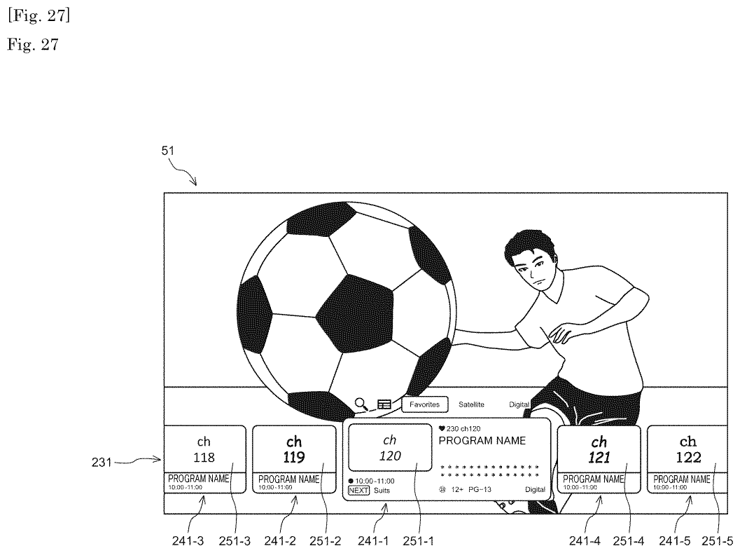

FIG. 27 is a diagram illustrating a second display form of program information superimposed on the image of the broadcast content in the television set 1. In FIG. 27, the broadcast content is displayed on the screen 51 of the display unit 14 as in FIG. 2. When the user performs a predetermined remote controller operation, a program information presentation section 231 is displayed at the bottom inside of the screen 51, superimposed on the image of the broadcast content. Pieces of program information 241-1 to 241-5 of different channels (broadcast stations) are displayed in the program information presentation section 231. The focused and enlarged program information 241-1 contains more detailed information than the other pieces of program information 241-2 to 241-5. The user can switch the focus to the program information by a remote controller operation. The focused program information is enlarged to display detailed information.

The pieces of program information 241-1 to 241-5 are displayed including pieces of program information corresponding to different channel numbers (three-digit numbers “118” to “122”), respectively, and each displayed including information such as the channel number, broadcast station name, program name, broadcast time, and so on. The program information 241-1 that is focused and enlarged is also displayed including detailed information such as program content (plot). The pieces of program information 241-1 to 241-5 can be displayed including image information and so on in regions 251-1 to 251-5 labeled “ch 118” to “ch 122”. Specifically, in each of the regions 251-1 to 251-5, any one of the corresponding broadcast content, program thumbnail, channel logo, channel number, and common channel icon image is displayed. The broadcast content is a preview image of the program displayed by the corresponding one of the pieces of program information 241-1 to 241-5. The broadcast content may be displayed only in the region 251-1 of the focused program information 241-1. Until broadcast content is acquired, program thumbnails may be displayed in the regions 251-1 to 251-5, respectively. The program thumbnails are acquired from a database site or the like, and are displayed in the regions 251-1 to 251-5 with their short sides fitted thereto or the like. If it takes time to acquire pieces of broadcast content or program thumbnails, the channel logos may be displayed in the regions 251-1 to 251-5, respectively, until the pieces of broadcast content or the program thumbnails are acquired. The channel logos that can be acquired through broadcasting are low resolution and too small to be handled widely, and therefore, high resolution channel logos may be managed on the company's own server or the like, and the television set 1 may be able to acquire high resolution channel logos via the Internet. If the channel logos cannot be acquired, the channel numbers may be displayed in the regions 251-1 to 251-5. Furthermore, the display of channel numbers may not be meaningful depending on the district, and therefore, in such cases, images that evoke TV channels, such as blank images, or other images may be displayed in the regions 251-1 to 251-5. According to the second display form of program information, it is possible to provide program information that looks good.

### <Third Display Form of Program Information>

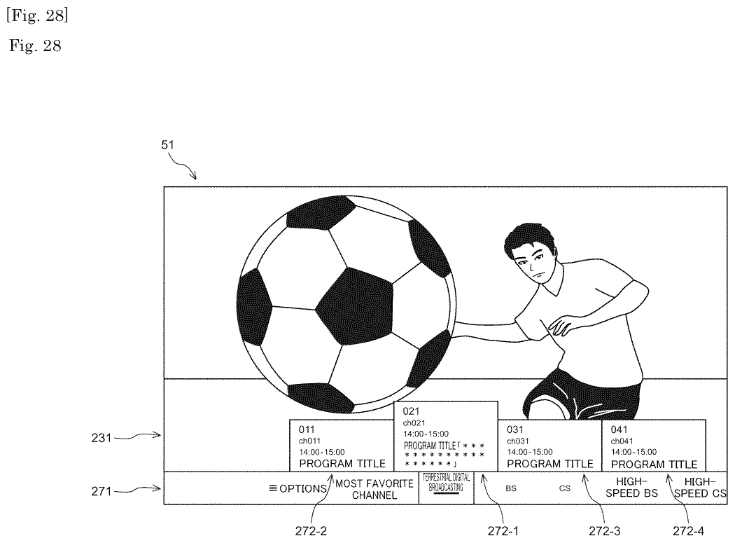

FIG. 28 illustrates a third display form of program information superimposed on the image of the broadcast content on the television set 1. In FIG. 28, broadcast content is displayed on the screen 51 of the display unit 14 as in FIG. 2. When the user performs a predetermined remote controller operation, the program information presentation section 231 and a group selection section 271 are displayed at the bottom inside of the screen 51, superimposed on the image of the broadcast content. Channels can be classified into several groups, such as regular channels, terrestrial digital broadcasting, BS broadcasting, CS broadcasting, and the like, and these groups are displayed in the group selection section 271. When the user selects one of the groups in the group selection section 271 by a remote controller operation, the program information of the channels belonging to that group is displayed in the program information presentation section 231. Each piece of program information displayed in the program information presentation section 231 is displayed including the channel number, broadcast station name, broadcasting time, and so on. Detailed information such as a description of the number is included in the focused program information to be displayed. According to the third display form of program information, the program information is displayed in order by group, making it easy to understand the image configuration.

### <Fourth Display Form of Program Information>

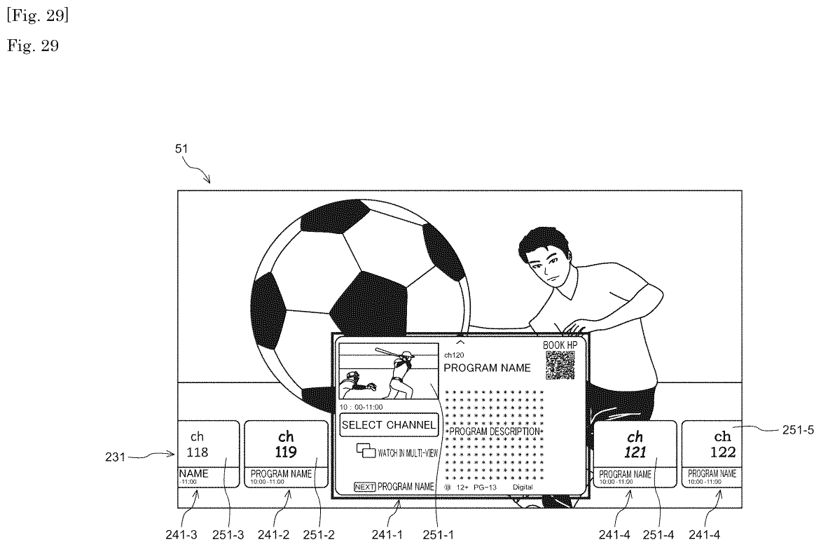

FIG. 29 is a diagram illustrating a fourth display form of program information superimposed on the image of the broadcast content in the television set 1. In FIG. 29, the broadcast content is displayed on the screen 51 of the display unit 14 as in FIG. 2. When the user performs a predetermined remote controller operation, the program information presentation section 231 is displayed at the bottom inside of the screen 51, superimposed on the image of the broadcast content. The pieces of program information 241-1 to 241-5 of different channels (broadcast stations) are displayed in the program information presentation section 231. The focused and enlarged program information 241-1 contains more detailed information than the other pieces of program information 241-2 to 241-5. The user can switch the focus to the program information by a remote controller operation.

The pieces of program information 241-1 to 241-5 are displayed including pieces of program information corresponding to different channel numbers (three-digit numbers “118” to “122”), respectively, and each displayed including information such as the channel number, broadcast station name, program name, broadcast time, and so on. The program information 241-1 that is focused and enlarged is also displayed including detailed information such as program content (plot). The pieces of program information 241-1 to 241-5 can be displayed including image information and so on in regions 251-1 to 251-5 labeled “ch 118” to “ch 122”. The display of image information and the like in the regions 251-1 to 251-5 is as described with reference to FIG. 27, and therefore, description thereof will be omitted here.

The focused program information 241-1 is also displayed including an operation button for selecting and viewing the channel and an operation button for viewing it as a multi-view image. When the user operates the operation button for multi-view on the program information 241-1 by a remote controller operation, the broadcast content currently being viewed by the user and the broadcast content of the program displayed in the program information 241-1 are displayed in multi-view. The focused program information 241-1 may be displayed further including a two-dimensional code such as a QR (registered trademark: Quick Response) code, so that the user can obtain more detailed program information by reading the displayed two-dimensional code with a smartphone or the like. The focused program information 241-1 may not be displayed all at once, but may be displayed stepwise by a predetermined remote controller operation (down key, etc.). The program information may be divided into several hierarchical layers, and information in lower layers may be displayed in sequence by a predetermined operation. According to the fourth display form of program information, while viewing a program, it is possible to search for another desired program and to watch these programs at the same time.

### <Program Search Screen>

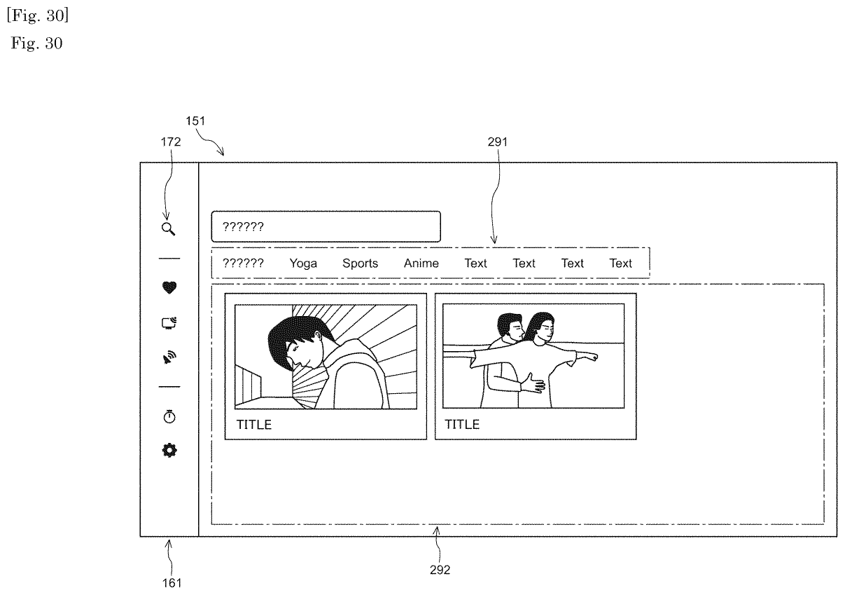

FIG. 30 is a diagram illustrating an example of a program information screen for program search. In the figure, parts common to the program information screen 151 of FIG. 21 are given the same reference numerals, and description thereof will be omitted. The program information screen 151 of FIG. 30 is displayed when the user selects a search icon 172 in the menu field 161 by a predetermined remote controller operation. The program information screen 151 of FIG. 21 is displayed when the user selects the icon 171 (see FIG. 21) in the menu field 161.

In a search term candidate field 291 on the program information screen 151 of FIG. 30, terms used in past searches as well as preset terms and genres are displayed. The user can select one term in the search term candidate field 291 by a remote controller operation, thereby searching for program information using the selected term. The search results are displayed in a search result field 292. This allows the user to easily search for programs the user wants to watch.

### «Eco Dashboard Function»

### <Configuration of Eco Dashboard Screen>

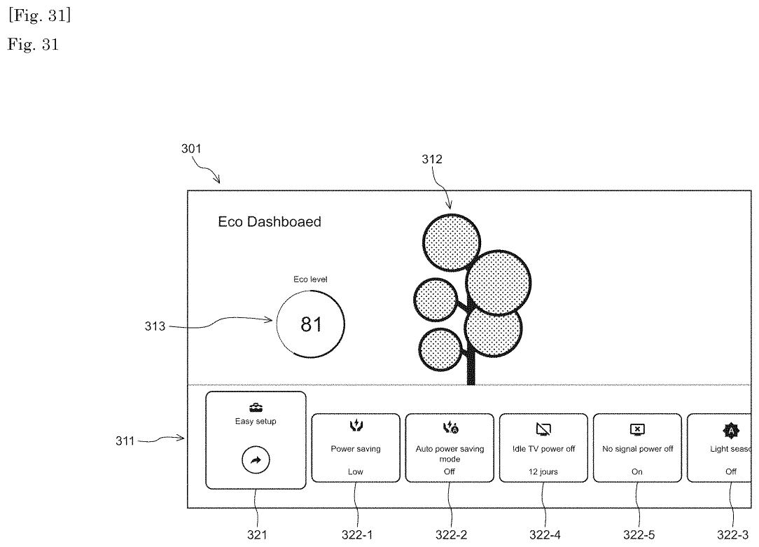

FIG. 31 illustrates an image example on an Eco dashboard screen. In FIG. 31, the Eco dashboard screen 301 is displayed on the screen 51 of the display unit 14 by a user's predetermined remote controller operation (execution of an Eco management app, etc.). In the Eco dashboard screen 301, a menu presentation section 311, an indicator 312, and an eco level meter 313 are displayed. In the menu presentation section 311, an “Easy setup” card 321, a “Power saving” card 321-1, an “Auto power saving mode” card 321-2, a “Light sensor” card 321-3, an “Idle TV power off” card 321-4, and a “No signal power off” card 321-5 are displayed. The “Power saving” card 321-1, the “Auto power saving mode” card 321-2, the “Light sensor” card 321-3, the “Idle TV power off” card 321-4, and the “No signal power off” card 321-5 are selected when individually setting five types of eco setup, “Power saving”, “Auto power saving mode”, “Light sensor”, “Idle TV power off”, and “No signal power off”, respectively.

Here, “Power saving” is a function that reduces power consumption by adjusting the screen brightness and the like. “Auto power saving mode” is a function that detects by the camera that no one is in front of the television set 1 and automatically enters a power saving state. “Light sensor” is a function that automatically adjusts the screen brightness according to the surrounding brightness to reduce power consumption. “Idle TV power off” is a function that automatically turns off the power after a certain period of time has passed without the TV being operated. “No signal power off” is a function that automatically turns off the power when there is no input signal for a certain period of time.

The “Easy setup” card 321 is selected when executing easy Eco setup that collectively performs five types of Eco setup, that is, “Power saving”, “Auto power saving mode”, “Light sensor”, “Idle TV power off”, and “No signal power off”. The indicator 312 qualitatively indicates the Eco level (the amount of effect on Eco) in the current Eco setup. The eco level meter 313 quantitatively indicates the eco level in the current eco setup.

### <Description of Indicator>

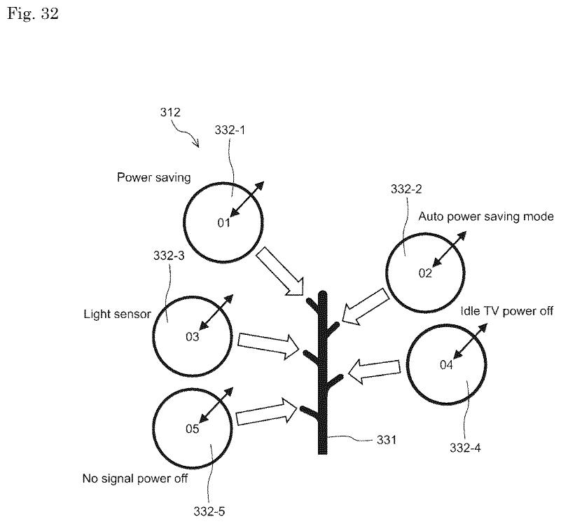

FIG. 32 is an explanatory diagram of the indicator 312. In FIG. 32, the indicator 312 is illustrated exploded, and the indicator 312 is composed of a trunk 331 (including branches) and leaves (branches and leaves) 322-1 to 322-5. The leaves 322-1 to 322-5 are each represented by a circle as a collection of leaves, and correspond to “Power saving”, “Auto power saving mode”, “Light sensor”, “Idle TV power off”, and “No signal power off”, respectively. The size (diameter) of each of the leaves 322-1 to 322-5 increases as the eco level in the corresponding eco setup increases. The size of each of the leaves 322-1 through 322-5 is predetermined relative to a setting value in the corresponding eco setup.

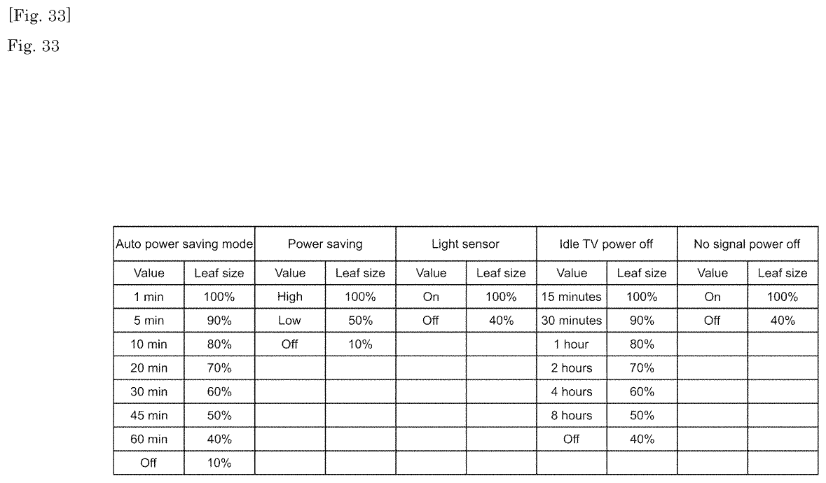

FIG. 33 illustrates an example of a lookup table that associates setting values in the eco setups, “Power saving”, “Auto power saving mode”, “Light sensor”, “Idle TV power off”, and “No signal power off”, with leaf sizes. For example, “Power saving” can be set to High, Low, or Off. When “Power saving” is set to High, Low, or Off, the size of the leaf 322-1 is set to 130%, 100%, or 40%, respectively.

### <Examples of Indicator>

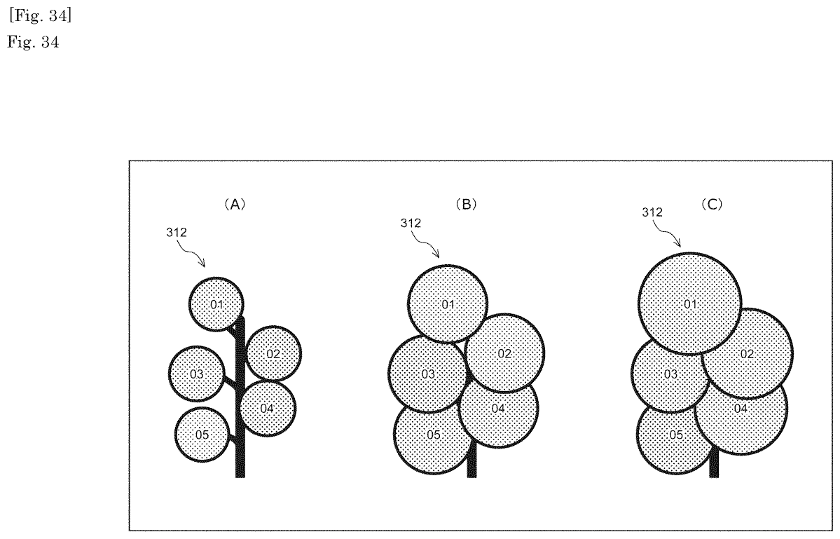

FIG. 34 is a diagram illustrating states of the indicator 312 depending on leaf sizes. In FIG. 34, (A) illustrates a case where the size of all the leaves 322-1 to 322-5 is 40%, that is, a case where all of “Power saving”, “Auto power saving mode”, “Light sensor”, “Idle TV power off”, and “No signal power off” are set to the minimum eco level. In FIG. 34, (B) illustrates a case where the size of all the leaves 322-1 to 322-5 is 100%. As illustrated in (C) of FIG. 34, it is possible to set the size of the leaves 322-1 to 322-5 to be larger than 100%. For example, in FIG. 34, (C) illustrates a case where the size of the leaves 322-1, 322-2, and 322-4 is 130%, and the size of the leaves 322-3 and 332-5 is 100%.

According to this, it can be seen that the more the indicator 312 gives the impression of having more leaves overall, the higher the eco level of the eco setting. The indicator 312 can also indicate the eco level in individual eco setup. The eco level meter 313 in FIG. 33 indicates, for example, an average value of the sizes of the leaves 322-1 to 322-5, making it possible to quantitatively recognize the overall eco level in the eco setups. The indicator 312 may take other forms. For example, the eco level meter 313 can also be considered as a form of an indicator.

### <Processing Procedure of Easy Eco Settings>

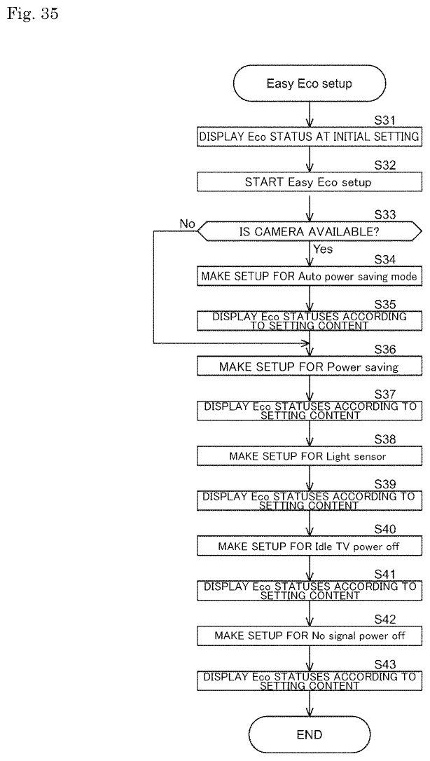

FIG. 35 is a flowchart illustrating a processing procedure of easy Eco setup. When the “Easy setup” card 321 in FIG. 33 is selected, the Eco management app (processing unit 11) proceeds to step S31. In step S31, the Eco management app displays the indicator 312 and the eco level meter 313 on the Eco dashboard screen 301 based on the eco status at the initial setting (current eco setup), that is, the setting values of the eco setups. In step S32, the Eco management app starts processing of easy Eco setup. In step S33, the Eco management app determines whether or not the camera 17 is available.

If the result in step S33 is no, the processing proceeds to step S36, and if the result is yes, the processing proceeds to step S34. In step S34, the Eco management app makes an eco setup for “Auto power saving mode” based on an input from the user. In step S35, the Eco management app displays eco statuses (the indicator 312 and the eco level meter 313) reflecting the setting content of “Auto power saving mode” on the Eco dashboard screen 301. In step S36, the Eco management app makes an eco setup for “Power saving” based on an input from the user. In step S37, the Eco management app displays eco statuses (the indicator 312 and the eco level meter 313) reflecting the setting content of “Power saving” on the Eco dashboard screen 301. In step S38, the Eco management app makes an eco setup for “Light sensor” based on an input from the user.

In step S39, the Eco management app displays eco statuses (the indicator 312 and the eco level meter 313) reflecting the setting content of “Light sensor” on the Eco dashboard screen 301. In step S40, the Eco management app makes an eco setup for “Idle TV power off” based on an input from the user. In step S41, the Eco management app displays eco statuses (the indicator 312 and the eco level meter 313) reflecting the setting content of “Idle TV power off” on the Eco dashboard screen 301. In step S42, the Eco management app makes an eco setup for “No signal power off” based on an input from the user. In step S43, the Eco management app displays eco statuses (the indicator 312 and the eco level meter 313) reflecting the setting content of “No signal power off” on the Eco dashboard screen 301. After the processing of step S43, the processing of the easy Eco setup ends.

### «Examples of Configuration Combinations»

The present technology can also be configured as follows.

(1)

An information processing device including a processing unit that sets a UI according to setting content of image/sound settings related to at least one of an image and sound of content to be viewed by a user.

(2)

The information processing device according to (1), wherein
the image/sound settings include a setting related to image quality or sound quality of the content, and
the processing unit sets the UI in response to the setting related to image quality or sound quality.
   (3)

The information processing device according to (2), wherein the processing unit sets at least a layout of the UI in response to the setting of image quality or sound quality.

(4)

The information processing device according to any one of (1) to (3), wherein the processing unit applies, as the UI, a UI corresponding to the setting content of the image/sound settings from among a plurality of types of UIs.

(5)

The information processing device according to any one of (1) to (4), wherein the processing unit makes the image/sound settings with the setting content according to a mode corresponding to a type of the content, and sets the UI according to the mode.

(6)

The information processing device according to any one of (1) to (5), wherein the UI is a UI corresponding to a multi-view image.

(7)

The information processing device according to any one of (1) to (6), wherein the UI is a UI corresponding to a game content image.

(8)

The information processing device according to (4), wherein the plurality of types of UIs include a UI corresponding to broadcast content.

(9)

The information processing device according to (6), wherein the UI corresponding to a multi-view image displays an image of focused content from among images of a plurality of pieces of content output in the multi-view, in a larger size than the images of the other pieces of content.

(10)

The information processing device according to any one of (6) to (9), wherein the UI corresponding to a multi-view image displays a menu at a position corresponding to an image of focused content from among images of a plurality of pieces of content output in the multi-view.

(11)

The information processing device according to any one of (6) to (10), wherein the UI corresponding to a multi-view image enables an operation on focused content from among a plurality of pieces of content output in the multi-view.

(12)

The information processing device according to any one of (6) to (11), wherein the UI corresponding to a multi-view image enables a plurality of pieces of content output in the multi-view to be changed in a state of the multi-view.

(13)

The information processing device according to any one of (6) to (12), wherein the UI corresponding to a multi-view image enables a mixing ratio of sound of a plurality of pieces of content output in the multi-view to be changed.

(14)

The information processing device according to any one of (6) to (13), wherein the UI corresponding to a multi-view image outputs only sound of focused content from among sound of a plurality of pieces of content output in the multi-view.

(15)

The information processing device according to (7), wherein the UI corresponding to a game content image enables a screen size of an image of the content to be viewed by the user to be changed.

(16)

The information processing device according to (7) or (15), wherein the UI corresponding to a game content image enables a display position of an image of the content that is to be viewed by the user to be changed.

(17)

The information processing device according to (4), wherein the plurality of types of UIs include a UI for content output by a camera app, and the UI corresponding to content output by the camera app generates illumination light when a shutter is released, based on an image of content output by the camera app.

(18)

The information processing device according to (4) or (17), wherein
the plurality of types of UIs include a UI corresponding to content output by a power consumption management app, and
the UI corresponding content output by the power consumption management app acquires from a lookup table a degree of effect indicating a magnitude of power consumption reduction effect for setting values of a plurality of settings related to power consumption, and performs presentation according to the degree of effect.

(19)

The information processing device according to (18), wherein the UI corresponding to content output by the power consumption management app acquires from the lookup table the degree of effect for each of the plurality of settings related to power consumption, and performs presentation according to the degree of effect for each of the settings.

(20)

An information processing method including setting,
by a processing unit of
an information processing device including the processing unit,
a UI according to setting content of image/sound settings related to at least one of images and sound of content to be viewed by a user.

Embodiments of the present disclosure are not limited to the above-described embodiments and can be modified in various manners without departing from the scope and spirit of the present disclosure. Moreover, the effects described in this description are merely examples and are not limited, and other effects may also be present.

### REFERENCE SIGNS LIST

1 Television set
11 Processing unit
12 Tuner
13 Communication unit
14 Display unit
15 Sound input unit
16 Sound output unit
17 Imaging unit
18 Sensor unit
19 Remote controller reception unit
20 Recording unit

1. An information processing device comprising a processing unit that sets a UI according to setting content of image/sound settings related to at least one of an image and sound of content to be viewed by a user.

2. The information processing device according to claim 1, wherein the image/sound settings include a setting related to image quality or sound quality of the content, and the processing unit sets the UI in response to the setting related to image quality or sound quality.

3. The information processing device according to claim 2, wherein the processing unit sets at least a layout of the UI in response to the setting of image quality or sound quality.

4. The information processing device according to claim 1, wherein the processing unit applies, as the UI, a UI corresponding to the setting content of the image/sound settings from among a plurality of types of UIs.

5. The information processing device according to claim 1, wherein the processing unit makes the image/sound settings with the setting content according to a mode corresponding to a type of the content, and sets the UI according to the mode.

6. The information processing device according to claim 1, wherein the UI is a UI corresponding to a multi-view image.

7. The information processing device according to claim 1, wherein the UI is a UI corresponding to a game content image.

8. The information processing device according to claim 4, wherein the plurality of types of UIs include a UI corresponding to broadcast content.

9. The information processing device according to claim 6, wherein the UI corresponding to a multi-view image displays an image of focused content from among images of a plurality of pieces of content output in the multi-view, in a larger size than the images of other pieces of content.

10. The information processing device according to claim 6, wherein the UI corresponding to a multi-view image displays a menu at a position corresponding to an image of focused content from among images of a plurality of pieces of content output in the multi-view.

11. The information processing device according to claim 6, wherein the UI corresponding to a multi-view image enables an operation on focused content from among a plurality of pieces of content output in the multi-view.

12. The information processing device according to claim 6, wherein the UI corresponding to a multi-view image enables a plurality of pieces of content output in the multi-view to be changed in a state of the multi-view.

13. The information processing device according to claim 6, wherein the UI corresponding to a multi-view image enables a mixing ratio of sound of a plurality of pieces of content output in the multi-view to be changed.

14. The information processing device according to claim 6, wherein the UI corresponding to a multi-view image outputs only sound of focused content from among sound of a plurality of pieces of content output in the multi-view.

15. The information processing device according to claim 7, wherein the UI corresponding to a game content image enables a screen size of an image of the content to be viewed by the user to be changed.

16. The information processing device according to claim 7, wherein the UI corresponding to a game content image enables a display position of an image of the content that is to be viewed by the user to be changed.

17. The information processing device according to claim 4, wherein the plurality of types of UIs include a UI for content output by a camera app, and the UI corresponding to content output by the camera app generates illumination light when a shutter is released, based on an image of content output by the camera app.

18. The information processing device according to claim 4, wherein
the plurality of types of UIs include a UI corresponding to content output by a power consumption management app, and
the UI corresponding to content output by the power consumption management app acquires from a lookup table a degree of effect indicating a magnitude of power consumption reduction effect for setting values of a plurality of settings related to power consumption, and performs presentation according to the degree of effect.

19. The information processing device according to claim 18, wherein the UI corresponding to content output by the power consumption management app acquires from the lookup table the degree of effect for each of the plurality of settings related to power consumption, and performs presentation according to the degree of effect for each of the settings.

20. An information processing method comprising setting,
by a processing unit of
an information processing device including the processing unit,
a UI according to setting content of image/sound settings related to at least one of an image and sound of content to be viewed by a user.
